(19) United States
(12) Patent Application Publication
(10) Pub. No.: US 2008/0005656 A1
(43) Pub. Date: Jan. 3, 2008

(54) Apparatus, method, and file format for text with synchronized audio

(76) Inventors: Shu Fan Stephen Pang, Monterey Park, CA (US); Chi Fan John Pang, Monterey Park, CA (US); Ping Pan Peter Pang, Monterey Park, CA (US); Christina Mullins, Carlsbad, CA (US)

Correspondence Address: THE NATH LAW GROUP, 112 South West Street, Alexandria, VA, 22314, US

(21) Appl. No.: 11/812,133

(22) Filed: Jun. 15, 2007

Related U.S. Application Data
(60) Provisional application No. 60/816,863, filed on Jun. 28, 2006.

(51) Int. Cl. G06F 17/00

(52) U.S. Cl. 715/500.1

(57) ABSTRACT

A method of synchronizing an audio narration of a text with a display of the text, in which the text and audio narration are encoded in a data file, includes: performing a page setup operation for displaying the text in a predetermined sequence; displaying the text in accordance with the page setup operation; outputting the audio narration of the text; and synchronizing the audio narration and the displayed text. Synchronizing information may be embedded in a text or audio portion of the data file. An associated apparatus includes a storage device, a display, and a processor. A file formatted for enabling a display of text and a synchronized audible narration of the text includes textual data corresponding to the text and audio data corresponding to the audible narration of the text. The textual data includes synchronization data embedded within the text, and can include page setup information sufficient for a processor to perform a page setup operation without the use of xml tags.

### CROSS-REFERENCE TO RELATED APPLICATIONS

This application claims the benefit of U.S. Provisional Patent Application No. 60/816,863, filed Jun. 28, 2006. The contents of this application are hereby incorporated by reference in their entirety.

### BACKGROUND OF THE INVENTION

1. Field of the Invention

The present disclosure relates to an apparatus, system, and method of synchronizing an audio narration of a text with a display of the text, in which the text and audio narration are encoded in a data file.

2. Related Art

Although many apparatuses and file formats exist today for delivering text and audio for various applications, they are not ideal for people who want to read books or other published content, while simultaneously listening to the synchronized audio on a small electronic device.

The file formats combining MP3s with lyrics usually present synchronized content line by line, but miss the page-setup information that is necessary for book reading. The conventional file formats for eBook applications can present text with page-setup, but lack the audio component. Although several newer eBook standards provide audio integration, each presents different drawbacks for applications in which people want to read and listen to synchronized narration at the same time. For example, the latest eBook format for Microsoft Reader (R) (Microsoft Corp., Redmond, Wash.) does not simultaneously deliver text with synchronized audio. Users must choose either text-reading or audio-hearing by switching between the two formats. In addition, eBooks for Microsoft Reader (R) (Microsoft Corp., Redmond, Wash.) can only be played on PCs, or large handheld devices, and not on portable devices such as devices of about the size of a cellular phone. Video formats for motion picture types of applications are also not suitable for reading synchronized text content on portable devices such as devices about the size of a cellular phone.

### SUMMARY OF THE INVENTION

The present disclosure solves the above deficiencies, by disclosing an apparatus, method, and file format for providing readable text with synchronized audio called “ReadandHear,” designed specifically to present highly readable text and well-synchronized audio. This new system, method, and file format enables the support for various types of new applications. These applications are new ways through which people can read text and simultaneously listen to synchronized audio on a small device about the size of a cellular telephone.

The present disclosure is directed to a method of synchronizing an audio narration of a text with a display of the text, in which the text and audio narration are encoded in a data file. The method includes: performing a page setup operation for displaying the text in a predetermined sequence; displaying the text in accordance with the page setup operation; outputting the audio narration of the text; and synchronizing the audio narration and the displayed text. Synchronizing information may be embedded in a text portion of the data file, or may be embedded in an audio portion of the data file, or a combination thereof.

In some aspects, the synchronizing information includes timestamps. In some aspects, the audio narration and text are encoded in the same data file. In other aspects, the text is stored in a first data file and the audio narration is stored in a second data file. In some aspects, the page setup operation utilizes null characters embedded in the text based on an anticipated display screen size. In some aspects, the page setup operation utilizes paragraph marks embedded in the text based on an anticipated display screen size. In some aspects, a synchronizing step occurs as part of the page setup operation. In some aspects, a synchronizing step occurs as part of the displaying operation.

The method may be implemented on a hand-holdable device having a display and an earphone jack. The method may be implemented on a hand-holdable device having a display and a speaker. In some aspects, the page setup operation addresses a readability factor such as: preventing a word from breaking across two lines; splitting a hyphenated word at the hyphen; and/or placing a page-break only after punctuation. In some aspects, the page setup operation is configured for a chapter-and-verse style document, such as the Bible.

The present disclosure is also directed to an apparatus for enabling a user to simultaneously read and hear a text. The apparatus includes a storage device configured to store data corresponding to the text and data corresponding to an audio narration of the text; a display for displaying the text; an audio output device for playing the audio narration; and a processor comprising instructions for synchronizing the audio narration and the text based on synchronizing information embedded in the text data, the audio data, or both.

In some aspects, the processor further comprises instructions for performing a page setup operation for displaying the text in a predetermined sequence, and the page setup operation addresses at least one readability factor selected from the group consisting of: preventing a word from breaking across two lines; splitting a hyphenated word at the hyphen; and placing a page-break only after punctuation.

In some aspects, the apparatus is contained within a hand-holdable device. In some aspects, the audio output device includes a speaker. In some aspects, the audio output device includes an audio output jack configured for use with headphones.

The present disclosure is also directed to a file formatted for enabling a display of text and a synchronized audible narration of the text. The file includes textual data corresponding to the text, and audio data corresponding to the audible narration of the text. The textual data includes synchronization data embedded within the text.

In some aspects, the textual data also includes page setup information sufficient for a processor to perform a page setup operation without the use of xml tags. In some aspects, the textual data is preconfigured for a display of a specified size.

The ReadandHear apparatus, method, and file format, alone and together, provide readable text with synchronized audio, ideal for ReadandHear applications. “Readable Text” refers to one or more features which facilitate the reading of text on a small screen or small device. Non-limiting examples of features which facilitate this reading include: a word can never be ‘broken up’ and get displayed on two lines; a hyphenated word can be displayed on two lines, but the split can only occur at the hyphen; and page-breaks can only occur after punctuation. This allows readers to follow the text content easily and comfortably.

The “Synchronized Audio” element in the new apparatus, method, and file format, enables the device to play corresponding audio such as narration of a book completely in-sync with the text. What a user sees on the screen is what is heard. In addition, with the ReadandHear format, even if a user varies the speed of narration, synchronization between audio and text remains whether the pace of the narration is slowed or quickened. The ReadandHear apparatus, method, and file format, alone and together, are a solution that contains all four types of information, text, audio, embedded page-setup, and synchronization, necessary for ReadandHear applications. This system provides many technical benefits, and offers a brand new way for people to read their favorite books for example, and at the same time, listen to its synchronized narration on a small device about the size of a cellular telephone.

Significant enhancements have been made to the existing synchronization and page-setup methods to provide better presentation results. In order to ensure that output ReadandHear files are downloaded properly from the development PC platform, to the small device about the size of a cellular telephone end-user presentation platform, a custom software has been created to ensure that all files are in the proper sequence and pertain to the content of the book or published material.

Together, the ReadandHear apparatus, method, and file format, the improved page-setup and synchronization methods, and the custom download software enable the development of functional ReadandHear applications. Through these ReadandHear applications, people can now comfortably read any books or published content and listen to synchronized narration on a small device about the size of a cellular telephone.

### BRIEF DESCRIPTION OF THE DRAWINGS

FIG. 1 charts a method for enabling a user to simultaneously read and hear a text according to the present disclosure.

FIG. 2 illustrates a presentation of text on a portable device, the presentation of text having part of the text missing.

FIG. 3 illustrates a presentation of text on a portable device according to the present disclosure, the presentation of text corresponding to a timestamp and a page.

FIG. 4 illustrates a further presentation of text on a portable device according to the present disclosure, the presentation of text corresponding to a timestamp later than the timestamp of FIG. 3, and a page later than the page of FIG. 3.

FIG. 5 illustrates a representation of a page of text as an array of character identifiers according to the present disclosure.

FIG. 6 illustrates a representation of a page of text according to FIG. 5, as an array of characters and character identifiers according to the present disclosure.

FIG. 7 illustrates a presentation of text according to FIG. 6, on a portable device according to the present disclosure.

FIG. 8 illustrates a representation of a page of text according to FIG. 6, as an array of characters and character identifiers formatted for readability according to the present disclosure.

FIG. 9 illustrates a presentation of text according to FIG. 8, on a portable device according to the present disclosure.

FIG. 10 illustrates a presentation of text according to FIG. 9, on a portable device, with a page number identified, according to the present disclosure.

FIG. 11 illustrates a representation of a page of text according to the present disclosure, as an array of characters identifiers formatted as a page.

FIG. 12a illustrates a first page of text formatted according to the present disclosure.

FIG. 12b illustrates a page of text, subsequent to the page of FIG. 12a, formatted according to the present disclosure.

FIG. 12c illustrates a page of text, subsequent to the page of FIG. 12b, formatted according to the present disclosure.

FIG. 12d illustrates a page of text, subsequent to the page of FIG. 12c, formatted according to the present disclosure.

FIG. 12e illustrates an array of characters identifiers formatted as a page, including a time stamp and page identifier according to the present disclosure.

FIG. 12f illustrates a page of text, subsequent to the page of FIG. 12d, formatted according to the present disclosure.

FIG. 13 illustrates a stored sound wave according to the present disclosure.

FIG. 14 illustrates the stored sound wave of FIG. 13, in which text and time-stamps are embedded according to the present disclosure.

FIG. 15 illustrates a failed attempt to place the first sentence of a verse on a line of a working page according to the present disclosure.

FIG. 16 illustrates a successful reformatting of the line of FIG. 15, placing the last incomplete word of FIG. 15 on a new line of a working page and utilizing null characters according to the present disclosure.

FIG. 17 illustrates a failed attempt to place a complete sentence on a single working page according to the present disclosure.

FIG. 18 illustrates a successful reformatting of the sentence of FIG. 17, removing a portion of the sentence following punctuation from a working page according to the present disclosure.

FIG. 19 illustrates the successful reformatting of the sentence of FIG. 18, where the removed portion of the sentence following punctuation is placed on a new working page according to the present disclosure.

FIG. 20 illustrates a working page for use in the page-break insertion process of the present disclosure, the working page shown before the insertion process begins.

FIG. 21 illustrates the working page of FIG. 20 after the insertion process has begin, in which a page number, total page number, chapter number, and verse number are shown.

FIG. 22 illustrates a later working page according to FIG. 20, in which a later chapter and verse are time-stamped.

FIG. 23 illustrates a display page formatted for the user, after the insertion process has been completed.

FIG. 24 illustrates a later display page formatted for the user, after the insertion process has been completed.

FIG. 25 illustrates an apparatus for enabling a user to simultaneously read and hear a text according to the present disclosure.

### DETAILED DESCRIPTION

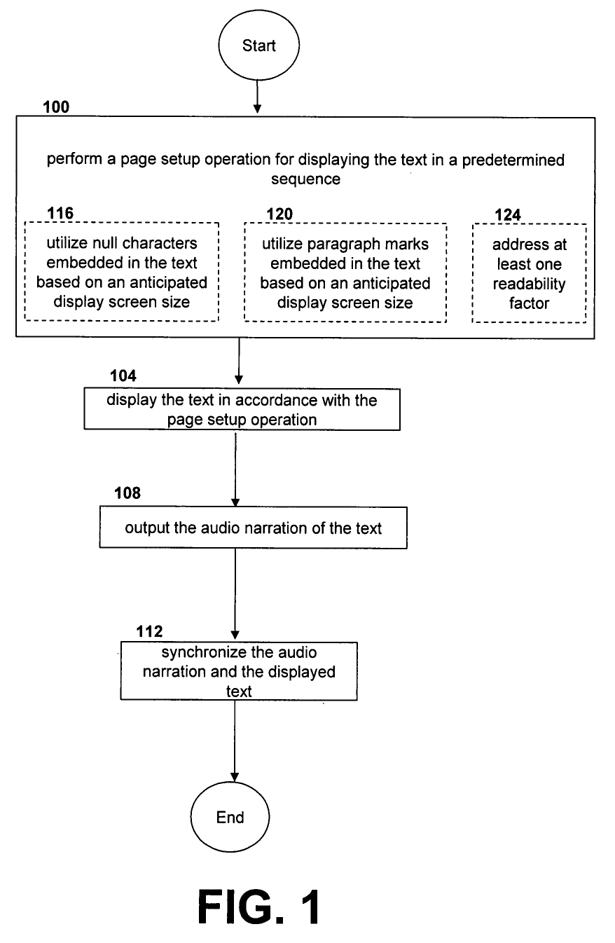

A method of synchronizing an audio narration of a text with a display of the text, the text and audio narration being encoded in a data file, will now be described with reference to FIG. 1. The described order of steps is only a non-limiting example, and the steps may be performed in any order. First, a page setup operation is performed for displaying the text in a predetermined sequence (step 100), based on stored page setup data downloaded to the display device. Optionally, the page setup operation step can include (step 116) utilizing null characters embedded in the text based on an anticipated display screen size; (step 120) utilizing paragraph marks embedded in the text based on an anticipated display screen size, or (step 124) addressing at least one readability factor, as will be discussed below.

Following the page setup operation, the text is displayed in accordance with the page setup operation (step 104). Then, an audio narration of the text is outputted (step 108). The audio narration and text display are then kept synchronized (step 112), optionally through the use of timestamps, which may be embedded in the test or audio data of the file. The synchronizing step may alternatively occur as part of the page setup operation, or as part of the displaying step. Text and audio narration may, but need not, be stored in the same data file.

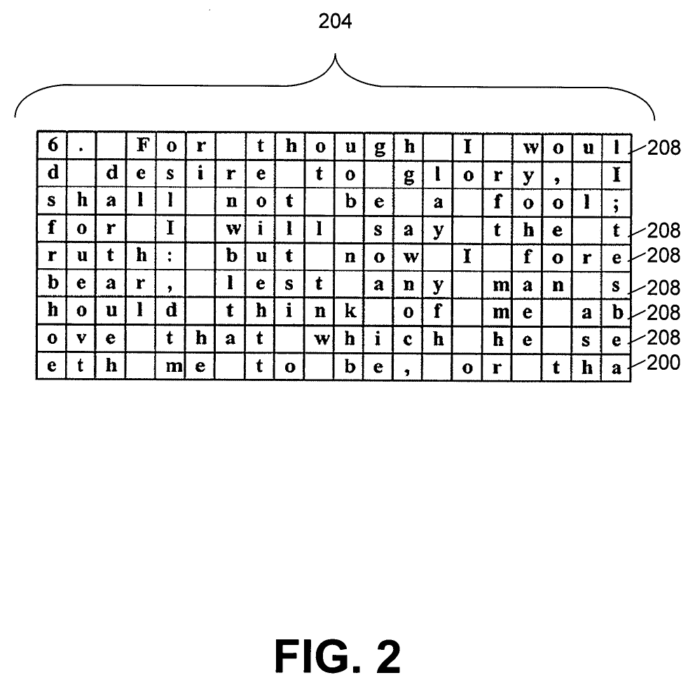

The method set forth above will now be discussed in detail with reference to FIGS. 2-25. To adequately characterize the advantages of the disclosed method, deficiencies in the present methods, apparatuses, and file formats, which have heretofore been proposed to provide synchronized text and audio, will initially be discussed.

Currently, several file formats claim to provide audio-text synchronization. Although these file formats perform well in the specific applications for which they are designed, they lack important features that are needed in developing ReadandHear applications.

ReadandHear applications let people read text and listen to synchronized audio simultaneously on a portable device such as a device about the size of a cellular phone. These ReadandHear applications provide highly readable text that is suitable for book-style reading. They also provide audio information that synchronizes well with the corresponding text. However, existing file formats and audio-text synchronization methods do not provide the necessary features and functionalities required for such applications. Below are key drawbacks of existing file formats and synchronization methods.

### I. Drawbacks of Existing Formats and Methods

### A. Not suitable for ReadandHear applications

### 1. Text with Synchronization, No Page-Setup

Currently, text files such as lyric files, when associated with MP3 or other audio formats, contain only text and timing information, and no page-setup information. These files are not suitable for applications where people want to read books or published content while simultaneously listening to the synchronized audio from a small device about the size of a cellular telephone.

Page-setup information is a critical element in audio-text synchronization technology. Page-setup information may organize the location of each letter of a word so that text content can be displayed in a neat and tidy way according to certain predefined criteria. Examples of page-setup criteria include, without limitation: a word cannot be broken up and get displayed on two lines; a hyphenated word can be displayed on two lines, but the split can occur at the hyphen; and page-breaks can only occur after punctuation. Page-setup information is used for the proper display of every word, sentence, phrase, paragraph, verse, etc., to preserve the integrity of the published document and to allow users to easily follow the content.

Although lyric files with synchronization information can be played with the corresponding audio files for karaoke, without page-setup information, the text displayed on the small screens of small electronic devices, for example, about the size of a cellular telephone is less than perfect for ReadandHear purposes. Lyric files are generally optimal for slower songs by synchronizing lyric phrase by phrase, then presenting the text of the phrases in a string on a narrow screen. For faster songs, however, the display time of the phrases is too short for people to sing along to the lyric. This pace of faster songs, for which karaoke-type lyric formats fail, is in fact very similar to the pace of text narration. Therefore, lyric files on MP3's are not optimal for ReadandHear applications in which one should be able to read the text comfortably at a normal pace and at the same time listen to synchronized narration.

### 2. Text with Page-Setup, No Synchronization

Generic text files that do have page-setup information, such as various electronic book formats that have been tried over the years, do not contain synchronization information. Although some text files can be played with a corresponding audio file, the lack of synchronization information makes it rather difficult, if not impossible, to follow the text along while listening to narration at the same time. This file format fails to provide an experience where you can see readable text on the screen and listen to synchronized audio.

### 3. Computerized Conversion of Text-To-Speech, Mechanical-Sounding Narration

Technology exists which can convert text to speech and integrate stored electronic speech into certain emerging eBook standards. The main disadvantage with current technology is that, although the words may be recorded by a human voice, the delivery of the sentences from the computerized conversion is mechanical, fragmented, and unemotional with respect to the subject matter of the content. This type of audio is not particularly appealing to people who want to enjoy their text materials read naturally by a person. People would prefer the audio to be delivered smoothly and with feelings.

### 4. Digital Talking Book by DAISY Requires Processing Too Heavy for Small Devices

The DAISY Consortium was formed by talking book libraries to lead a worldwide transition from analog to digital “talking books.” DAISY denotes the Digital Accessible Information SYstem. Their recent standard, called Digital Talking Book (DTB), does provide a way to present text with corresponding audio. However, DTB is XML based, and relies on SMIL (Synchronized Multimedia Integration Language) to store synchronization data in XML databases. XML is usually quite verbose, and requires very heavy processing of the kind not-suited for a small, often battery-operated, portable device. Moreover, this SMIL logic stores one or more extra SMIL files in a DTB fileset. The SMIL files reference separate audio and text files, and guide the combination of these objects through the use of large XML tags. The present apparatus, method, and file format provide distinct advantages over DTB and DAISY, as they do not rely on XML parsers, which cannot run effectively and efficiently on small devices. An additional advantage is the storage and retrieval of fewer files (as no synchronizing SMIL file is needed), and the reduction in processing power needed when synchronizing is based on embedded information, and not on a SMIL index file. XML parsers, which can easily exhaust the memory resources of a smaller device, are far from optimal for the presently disclosed uses. Therefore, DTB format is not optimal for ReadandHear type devices.

In addition to the fact that DTB technology requires too much processing for a small device about the size of a cellular telephone, it is also not designed for ReadandHear applications. According to the abstract in the Specifications of Digital Talking Book (DTB), “DTBs are designed to make print material accessible and navigable for blind or otherwise print-disabled persons”. DTB application is geared more toward providing tools for the visually impaired community to hear and navigate books on a PC or a networked platform than for users to read and hear books simultaneously on a small device about the size of a cellular telephone.

5. eBook for Microsoft Reader, Requires Switching Between Audio and Text

Microsoft Corp. touts its eBook solution as enabling consumers to freely switch between the audio and text versions of an eBook so, for example, they can choose to read the text of one chapter and then listen to another chapter being read aloud. This feature basically allows you to select whether you want to read the text or listen to the narration of the text. However, the text-reading and the audio-hearing are not simultaneous. In addition, eBooks for Microsoft Reader (R) (Microsoft Corp., Redmond, Wash.) can only be played on PCs, or large handheld devices, and are not configured for play on portable devices such as devices about the size of a cellular phone.

### 6. Video with Synchronized Audio, not Optimal for Text Display

File formats for video such as MPEG can play moving images with synchronized audio. However, these files are designed for motion pictures in frames and pixels with compression. They are not optimal for ReadandHear applications such as book reading on portable devices about the size of a cellular phone, which require clear text display with small font size and interactivity with words and characters. Moreover, the storage of actual graphical representations of the words, instead of the underlying text, wastes valuable processor power, memory, and preparation time.

### 7. Other Formats, Too Large for Portable Devices

Other file formats, such as those for CD-ROMs and DVDs with subtitles, are designed for PCs and bigger electronic devices, not portable devices about the size of a cellular telephone. In addition, the text in subtitles and open or closed captioning are mainly designed for use in videos and films played on a television or a PC. These are also not suitable for book-reading on portable electronic devices.

### B. Problems Associated with the Lack of Page-Setup or Inefficient Page-Setup

### 1. Problems Associated with the Lack of Page-Setup

Proper page-setup is essential for audio and text synchronization since book narration usually has a much faster pace than song lyric delivery. Files without page-setup are unusable for ReadandHear applications due to the following problems:

a. Broken Words

Because there is no page-setup information, a single word can often get broken up and get displayed on two separate lines on the screen. A word can be broken up at any alphabet, making it hard to read. Let us use the following scripture (2Cor. 12:6) as an example.
“6. For though I would desire to glory, I shall not be a fool; for I will say the truth: but now I forbear, lest any man should think of me above that which he seeth me to be, or that he heareth of me.”
   Referring to FIG. 2, if the above scripture is displayed (2Cor. 12:6) on a 9×20 characters screen 204 (9 rows×20 columns) of a small size device without any prior page-setup information, the presentation on the screen will appear as shown in FIG. 2, with ‘broken’ words 208.
   b. Missing Part of the Text

Another problem with the lack of page-setup information is that the bottom part of the text content may not get displayed at all. This is because, when the size of the text context between two page-break points is longer than the display screen size, the bottom part of the text content will be missing from the display. For example, if the paragraph has 200 characters, and the 9×20 screen only allows display of 180 characters, then at least 20 characters of this paragraph will not be displayed.

In order to synchronize audio with text, the synchronization is normally done at the text unit level. A text unit can be a sentence, a paragraph, a verse, a page of a document file, or a page of a paperback book. Time-stamps are generated at the beginning of each text unit to indicate the page-break points.

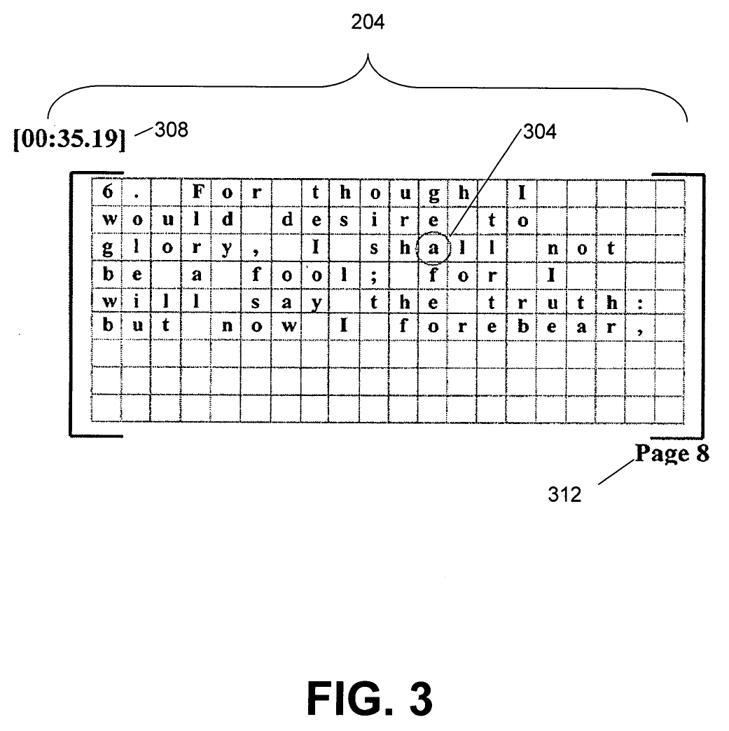

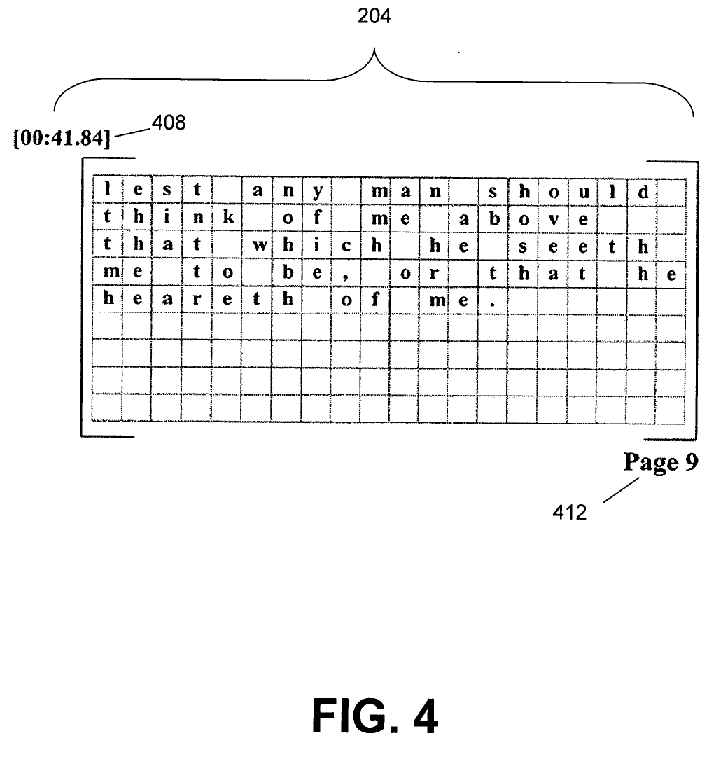

Referring to FIGS. 3 and 4, the following scripture is presented as an example:
[00:35.19]6. For though I would desire to glory, I shall not be a fool; for I will say the truth: but now I forbear, lest any man should think of me above that which he seeth me to be, or that he heareth of me.
[00:47.78]7. And lest I should be exalted above measure through the abundance of the revelations, there was given to me a thorn in the flesh, the messenger of Satan to buffet me, lest I should be exalted above measure.

To synchronize audio with the above scripture verse by verse, the verses will be time-stamped. For the scripture above, the first verse (verse 6) is 35 seconds and 19 milliseconds long, and the second verse (verse 7) 47 seconds and 78 milliseconds long. Without page-setup information, the display on the small device will appear as shown in FIG. 2, with part of the text missing. In FIG. 2, note that the last part of the verse “that he heareth of me” is not displayed on the screen 204, truncation occurring at the last letter 200. This is because the previous verse is longer than what the screen can accommodate. This verse gets truncated and will be out of sync with the audio before the page-break of the next verse.

### 2. Problems Associated with Inefficient Page-Setup

Known audio and synchronized text solutions on small devices do not have page-setup information. Accordingly, in order to present synchronized text neatly, a page-setup process is typically performed in real-time. This presents a serious problem for small devices that generally have limited processing capabilities. The processor of the small device has to handle the page-setup process through trial-and-error in real-time, while simultaneously outputting the synchronized text neatly and playing the MP3 or other audio file smoothly. The processor can get overloaded from performing these tasks.

To validate the above theory, a test was performed using existing MP3 and lyric files to create an application to read and listen to synchronized audio on a portable device. For the test, a customized real-time page-setup process was developed. Since computing resource is limited on the small electronic device, the page-setup process was given high priority to resources. However, even with this high priority, the device failed to present the text in sync with the corresponding audio. It also failed to play the audio smoothly. The results of the presentation were unsatisfactory.

### C. Drawbacks of Existing Initial Synchronization Methods

Many methods exist today in order to initially synchronize audio and text (that is, to determine the synchronization points for given text and audio sources). These methods include voice recognition (matching recognized words in the audio stream to recognized words in the text stream), and silence (matching pauses in the audio stream to punctuation in the text stream). These and other existing methods may be fully computerized. Although fully computerized methods are efficient, even today, they are not 100% accurate. There are always a certain percentage of synchronization results that need to be corrected or fine tuned through human interaction.

Synchronization errors can occur due to a number of reasons. First of all, many narrations have background music. Therefore, using silence to determine the end of a sentence or a phrase may not always work accurately. Moreover, since the style and speed of narration is different from person to person, it is difficult for the software to determine the end of a sentence by using silence as the indicator. In addition, computers continue to perform poor speech recognition when normal, narrative inflection is used. Any or all of these can lead to synchronization errors.

### D. Disadvantages of Using Multiple File Formats for ReadandHear Applications

With existing file formats, information such as text, audio, page set-up, and synchronization are stored in multiple separate files. There are many disadvantages of using multiple file formats to support synchronization applications. These include:
1. Poor presentation quality
   The use of multiple files and file formats leads to high simultaneous processing and system-bus demands, which can create unnatural pauses in the text and audio.
2. There are more files to manage
   The use of multiple files and file formats is often too inefficient for small electronic devices about the size of a cellular telephone to deliver satisfactory presentation of synchronized audio and text data for ReadandHear applications.
3. Not user friendly
   In order to play audio and synchronized text files for synchronization applications, the separate files have to be linked together. This can be accomplished by using the exact file names (with different extensions), and storing them in the same directory. When performed by the end user, problems can easily arise. File names that are thought to be the same may not be exactly the same. For example, there is uppercase ‘A’ vs. lower case ‘a’, ‘first’ vs. ‘1^{st}’, and underscore ‘_’ vs. hyphen ‘-’. Also, files that are thought to be stored in the same location turn out to be in different directories. Finding the missing pieces can be a daunting task.
4. More efforts involved in copyrights
   For book publishers, it is easier to handle a single file than multiple files, in relation to copyright issues and encryption.
5. More time required for downloading content

### II. Advantages of the Disclosed Apparatus, Method, and File Format

### A. The Presently Disclosed ReadandHear File Format

### 1. Design Goals of the ReadandHear File Format

Due to the drawbacks of the existing file formats and methods for synchronization applications, a new file format has been created to provide presentation of highly readable text with synchronized audio for device about the size of a cellular telephone. This new file format may be called ReadandHear (Readable Text with Synchronized Audio). The ReadandHear file format has the file extension of ‘.ats’ which stands for Audio-Text in Sync. The ReadandHear file format is designed specifically for synchronization applications, which may be called “ReadandHear applications,” to enable users to read any book or published content while simultaneously listening to the synchronized audio, all on a device about the size of a cellular telephone.

### 2. ReadandHear Apparatus, Method, and File Format are Different from the Previous Formats.

a. The file formats which combine MP3s or other audio files with lyrics usually present synchronized content line by line but lack the page-setup information that is necessary for book reading. The ReadandHear format provides immediate page-setup information for producing readable text.
b. eBook (known electronic text) formats

i. The conventional file formats for eBook applications can present text with page-setup, but lack the audio component. The ReadandHear format includes audio.

ii. The eBook standards utilize computerized text-to-speech conversion to deliver audio content that sounds mechanical and not appealing to users for book-reading purposes. The ReadandHear format includes actual audio recordings by a human, with natural breakpoints.

iii. The relatively new eBook standard Digital Talking Book (DTB) can present text with synchronized audio, however, DTB requires the heavy processing demands of XML and a separate SMIL synchronizing index file, and is primarily designed for the visually impaired community to hear and navigate books on a PC or a networked platform. The ReadandHear format relies on embedded synchronization instructions with low processor demands.

iv. The latest eBook format for Microsoft Reader (R) (Microsoft Corp., Redmond, Wash.) provides audio integration, but does not simultaneously deliver text with synchronized audio. Users must choose either text-reading or audio-hearing by switching between the two. In addition, eBooks for Microsoft Reader (R) (Microsoft Corp., Redmond, Wash.) can only be played on PCs, or large handheld devices. The ReadandHear format may be used on portable devices such as devices about the size of a cellular phone.
c. The video formats for motion pictures usually present data in pixels with compression, which is not optimal for clear text display and text interactivity on small devices about the size of a cellular telephone. The ReadandHear format is optimal for this size of device.
d. The file formats for CD-ROM, DVD, subtitles and captioning which require a PC or an electronic device that is much bigger, more expensive, and more resource intensive than a device about the size of a cellular telephone to play or display. The ReadandHear format is optimal for this size of device.

### 3. The ReadandHear File Format Comprises the Following Information:

a. Text information
b. Audio information
c. Page-setup information for text display
d. Synchronization information

### 4. Key Benefits of the ReadandHear File Format

a. Presentation of Highly Readable Text and Synchronized Audio.

The ReadandHear file format delivers the best presentation results for ReadandHear applications on devices about the size of a cellular telephone. Text is displayed in a highly readable format for people to easily follow the content of the published information, with proper page-breaks, and no ‘broken’ words or missing sentences.

The ReadandHear file format enables the device about the size of a cellular telephone to play the audio smoothly while in sync with the displayed text. In addition, people can also easily locate, bookmark, or pause at any page. Even if one varies the speed of narration, synchronization between audio and text remains whether you slow down or speed up the pace of the narration.

b. Page-Setup and All Necessary Information are Stored in a Single File

Page-setup information, along with all necessary data such as text, audio, and time-stamps, can be combined in a single ReadandHear file. Having the page-setup information built into the file, e.g. embedded in the text or audio, along with other necessary data, provides tremendous technical benefits as well as presentation benefits.

Page-setup information defines the location of each letter of a word so that the text content can be displayed in a neat and tidy way according to certain predefined criteria. Proper page-setup assures readability. Non-limiting examples of features which facilitate readability include: a word cannot be ‘broken up’ and get displayed on two lines; a hyphenated word can be displayed on two lines, but the split can only occur at the hyphen; and page-breaks could only occur after punctuation. Page-setup information is crucial for the proper display of every word, sentence, phrase, paragraph, verse, etc., to preserve the integrity of the published document and to allow users to easily follow the content.

c. Better Real-Time Performance

A small device about the size of a cellular telephone typically has a processor which is not fast enough to construct page-setup from scratch in real-time while simultaneously presenting text and audio smoothly and synchronously. The ReadandHear file format helps solve this problem by having the page-setup information prepared and incorporated into the file in advance. The ReadandHear format helps offload heavy and busy tasks of real-time page-setup and other processing from the device processor to the initial file setup device. Since page-setup information may be preconfigured, stored, and readily available, the real-time presentation process can be dramatically more efficient. This allows the device to display text properly on the screen, to synchronize text and audio, and to play audio in high fidelity without taxing demands on processing and memory.

Even for devices that may have enough processing power, it is still better to free the processor from page-setup tasks so that it can perform other tasks, to provide better overall performance and improved energy efficiency. The use of ReadandHear file formats helps reduce costs of production and use, because they can work with more cost-effective processors.

d. Fewer Files to Manage

In addition to eliminating the need for real-time page-setup, the ReadandHear file format also reduces the need for managing, processing, and decrypting a large number of files in multiple formats.

It takes at least two files (MP3 file and lyric file) to play MP3 audio with lyric display. With ReadandHear, the number of files to manage is reduced to about half of what other formats would require. For example, the number of ReadandHear files for the whole Bible is 1,189 files with one file per chapter. If the Bible were to be implemented in formats such as MP3 and lyric, the number of files would have been 2,378 not including all the page-setup information.

e. More User Friendly

For end-users employing ReadandHear file formats, there is no need to search for other related lyric or audio files, to worry about the naming of the related files, or to download large number of files in multiple file formats.

f. Simplify Copyrights Process

In regards to copyright issues, encryption and decryption, it is easier for book publishers to handle a single file encompassing the ReadandHear information than multiple files.

g. Take Less Time to Download Content in Production

In general, the time it takes to download a collection of files (whether downloaded by the user onto a device, or downloaded by a vendor when preparing the device for sale) not only depends on the overall file size, but also very much depends on the overall numbers of files being transferred, since there is overhead for downloading each and every file. The downloading of a sets of MP3 (audio) files, lyric (text) files and ReadandHear files (the latter comprising both audio and text data) were tested. It was found that the ReadandHear single file format downloaded much faster than the others. Table 1 shows elapsed download times for each file format through USB 1.1.

TABLE 1

| | | | | Download |
|---|---|---|---|---|
| Test | File Format | Number of Files | Total File Size | Time |
| 1 | lyric | 1,189 | 5.38 M | 25 min 30 s |
| 2 | MP3 | 14 | 5.60 M | 39 s |
| 3 | ReadandHear | 14 | 5.64 M | 39 s |
| 4 | MP3 | 1,189 | 904 M | 72 min 06 s |
| 5 | ReadandHear | 1,189 | 910 M | 72 min 01 s |

Referring to Tests 1, 2, and 3—Even though the file sizes are about the same, it took almost 25 minutes longer to download the lyric files and MP3s separately, than to download the ReadandHear files. This is due to the large number of lyric and MP3 files (over 1200 together) as compared to the number of ReadandHear files (only 14) that need to be downloaded, since each ReadandHear file combines at least one MP3 worth of audio with over fifty text files worth of text. Each of the thousand lyric files incurred processing overhead which adds to the longer time it took to download.

Referring to Tests 1, 4, and 5—The download of both lyric and its corresponding MP3 files is over 35% longer than that of ReadandHear files, as shown by:

[(test1+test4)−test5]/test 5

[((25×60+30)+(72×60+6))−(72×60+1)]/(72×60+1)=35.5%

In other words, there is an over 26% improvement in download time of ReadandHear files than both lyric and its corresponding MP3 files, as shown by:

[(test1+test4)−test5]/(test1+test 4)

[((25×60+30)+(72×60+6))−(72×60+1)]/[(25×60+30)+(72×60+6)=26.2%

Fast download is particularly important for book publishing since downloading of content is required for products which are to be produced in mass quantity. The ReadandHear format saves time and effort.
h. Multi-Language Support

Besides English, the ReadandHear format and its methodology can be applied to all other alphabetical languages such as Spanish, French, and German. It can also be applied to graphical characters such as Chinese, Japanese, and Korean. The methodology for alphabetical characters is similar to that of English. However, for the graphical characters (Chinese, Japanese, Korean), there is a slight difference. Since every single graphical character itself represents a word, there is no need to worry about a word being broken up for display into two lines (although other readability factors should be attended to).

### B. Novel Enhanced Synchronization Methods

### 1. Design Goals of the Enhanced Synchronization Methods

As described above, many of the methods in existence today for audio and text synchronization are fully computerized. Although these methods are efficient, they are far from 100% accurate. Enhancements have been made in this area in order to produce good synchronization results.

### 2. Enhanced Methods

a. In order to determine exactly which phrases are synchronized, special human listening skills must be relied upon. Based on time-stamps generated by a human operator, the computer displays text on a working page on the screen for a specific duration of time. At an early stage of preparing the text or audio file to include synchronization markers, human involvement in certain aspects of the synchronization process is necessary to enable synchronization to work seamlessly.
b. Since human processing is time consuming, the ideal synchronization method combines a computerized process and a manual ‘click-on-the-page-break-point’ process. It is better to use software to synchronize most of the book first, then use human to help fine tune or correct a small percentage of the unsatisfied synchronization results. Accordingly, ReadandHear files are designed to contain embedded synchronization timestamps, which may be initially placed by an automated process, and then may be flexibly aligned and adjusted by a human operator.

### C. Novel Enhanced Page-Setup Methods

### 1. Design Goals of the Page-Setup Methods

Page-setup methods carry the location of each letter of a word so that the text content can be displayed in a neat and tidy way according to certain predefined criteria. Page-setup is particularly important when the screen display is very small such as that of a portable device such as a device about the size of a cellular phone. New page-setup criteria were created to ensure proper display of every word, sentence, phrase, paragraph, verse, etc., which is crucial to preserve the integrity of the published document and to allow users to easily follow the content.

### 2. Enhanced Methods

Additional conditions may be added to existing page-setup criteria for determining page-break points: For example:
a. A sentence ended with punctuation such as“.” or “,” cannot be broken up for display on 2 pages. In other words, page-breaks can only occur after punctuation.
b. For Bible reading (or other texts so organized), a page-break occurs after the end of each verse.
c. If there are page-breaks within a paragraph or a verse, the last page is checked to see if there are too few words to display for the entire screen of the last page. If so, then the previous sentence that ends with punctuation from the preceding page is taken and placed on the last page as well.

### D. Novel Custom Download Utility

### 1. Design Goals of the Custom Download Utility

During the download process of ReadandHear output files from a PC development platform to the portable devices for end-users, the operating system may at times send the files to the device not in the same order as they are sorted and stored on the PC. In addition, the file order may be inconsistent every time that the operating system downloads the same set of files to different devices. Such a file-order change causes books or chapters to be out of sequence when indexing on the device. Customized software may be used in the portable apparatus to properly arrange the book directory and chapter files for a specified indexing sequence.

### 2. Enhanced Methods

When the chapter files are sent to the device, the custom ReadandHear software on the device will check the name of the file against the names on an existing list. If the file belongs to a certain book directory, then the file will be placed into a memory buffer of that directory. Then, based on a stored indexing sequence, the files of that directory will be arranged in the proper order before they are placed in a specified memory location that is reserved for that book directory for a specified indexing sequence. This method applies not only to the Books and Chapters of the Bible for example, but the books and chapters of other publications such as an encyclopedia as well.

### III. Examples of Output in ReadandHear Format

The ReadandHear file format includes text, audio, synchronization and page-setup information all in one file. This format allows display of text content on even a very small screen such as that of a portable device about the size of a cellular phone. Text content also displays in sync with the corresponding audio. Before proceeding to discuss in detail the methods involved in creating the new ReadandHear format, an example of what ReadandHear output data and the display of such data would look like will be given.

### A. Example of Output Text Data in ReadandHear Format

Referring to FIGS. 3 and 4, portions of the output text files, formatted for readability, and having time-stamps in the upper left corner, are illustrated.

### B. Example of Actual Display of Output Text Data in ReadandHear Format:

Referring to FIG. 3, the illustrated page-setup text is shown as displayed on the screen 204 from [00:35.19] to [00:41.84]. The starting time stamp 308 and page number 312 are shown for illustrative purposes in FIG. 3, but need not in fact be shown to the user. Referring to FIG. 4, the illustrated page-setup text is shown as displayed on the screen 204 from [00:41.84] to [00:47.78]. Again, the starting time stamp 408 and page number 412, both subsequent to those displayed in FIG. 3, are shown for illustrative purposes, but need not be shown to the user. Notice also that the text data of the ReadandHear file (as quoted above) and the actual display of the output text data on the screen during book reading are very similar. This is because the output text data in ReadandHear format already has embedded information on page-setup and synchronization, allowing the device to simply display the output. ReadandHear format on the small electronic device is extremely efficient in real-time performance. Although the page size in this example is 9×20, the methods and file formats disclosed herein can work with any screen size. The text in ReadandHear format will be always display neatly without broken words or missing text. Since there is corresponding narration in this example, the display of the text will synchronize with the audio using the time-stamp of each page. Also, the total duration for the text pages to appear on the screen is usually the same as or slightly shorter than the duration of the corresponding audio data. This is because there may be some background music or silence before the actual narration starts.

### IV. Methodology for Defining the ReadandHear Format

### A. Steps in Building the ReadandHear Format are as Follows:

1. Define the basic unit of text
2. Define “page” as an array of characters
3. Define “page-setup page” as an array of “page-setup characters”
4. Define “page-setup chapter” as a series of “page-setup pages”
5. Define “time-stamped and page-setup chapter” as a series of “time-stamped and page-setup pages”
6. Add audio elements to the new format
7. Define the new format with audio and text
   In the following examples, timestamp data are embedded in the textual page. However, this is a non-limiting example, and timestamp data may alternatively be embedded in the audio data. Moreover, this is merely one example of a format for providing synchronized text and audio. Other formats may be used, and will be clear to one skilled in the art upon reading the present disclosure.

### 1. Define the Basic Unit of Text

First, the ReadandHear format may be generalized with a mathematical model. Mathematically, any character in a word, or punctuation in a page can be located with two coordinates, i and j. The coordinate ‘i’ is the row number and ‘j’ is the column number. Together, they indicate the location of a character within the page on the screen. In general, any character can be expressed as chᵢⱼ. For example, in FIG. 3, the circled letter ‘a’ 304 is in row 3, column 12, hence the coordinates of the letter ‘a’ are 3 and 12. ‘a’ may be expressed as ch_{3 12}.

### 2. Define ‘page’ as an Array of Characters

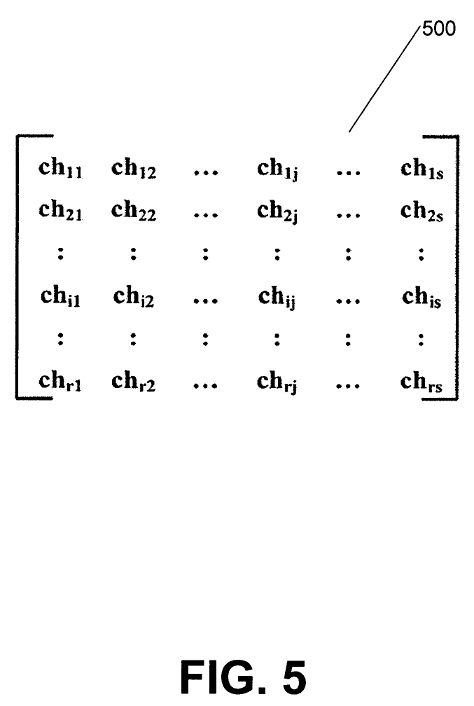

For a fixed page size (r, s) where r is the total number of rows and s is the total number of columns, an array of characters can be used to represent the characters of this page. Referring to FIG. 5, define page as an array of characters 500 as shown. For simplicity, let us use (chᵢⱼ)^{r×s} to represent the array in FIG. 5. Hence

page=(chᵢⱼ)^{r×s} (Equation 1).

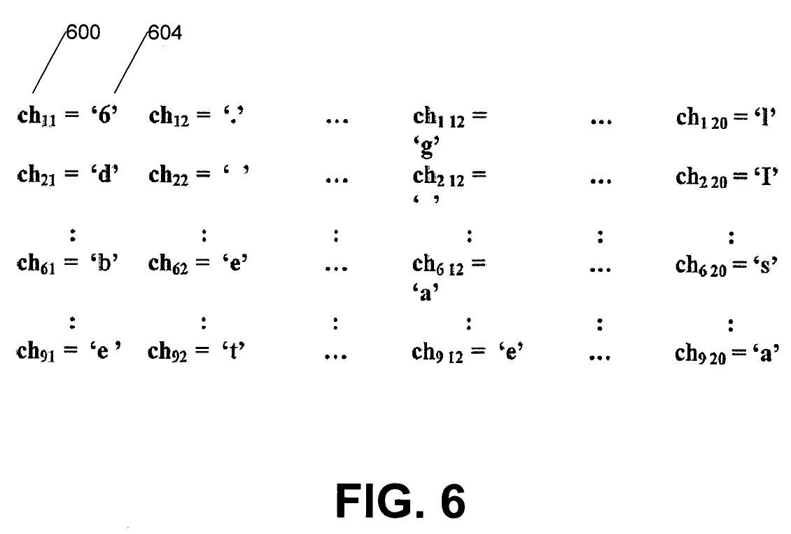

This equation represents a page (r rows×s columns) on which each character chᵢⱼ is located in row i and column j. For example, using the same verse as shown in FIG. 1, substitute values into the variables of the equation. Referring to FIG. 6, the page=(chᵢⱼ)^{9×20} is illustrated as an array of characters 604 and character identifiers 600.

3. Define ‘page-setup page’ as an Array of page-setup characters let us define P as an already page-setup page on which the characters are already properly arranged. Therefore, P=page-setup page=page-setup(chᵢⱼ)^{r×s} (from Equation 1). To emphasize the page set-up quality, differentiate (chᵢⱼ)_{r×s} by use of the square brackets, hence defining [chᵢⱼ]^{r×s} as an already page-setup array (chᵢⱼ)^{r×s} with neatly arranged characters (chᵢⱼ). Hence,

P=page-setup page=page-setup(chᵢⱼ)^{r×s}=(page-setup chᵢⱼ)^{r×s}=[chᵢⱼ]^{r×s} (Equation 2).

P represents an already page-setup page (r rows×S columns) on which each character chᵢⱼ is neatly arranged in row i and column j.

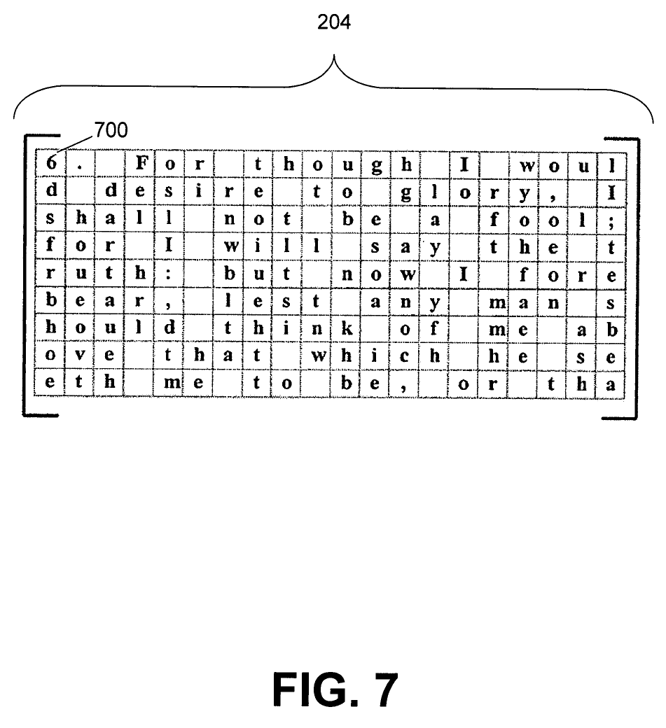

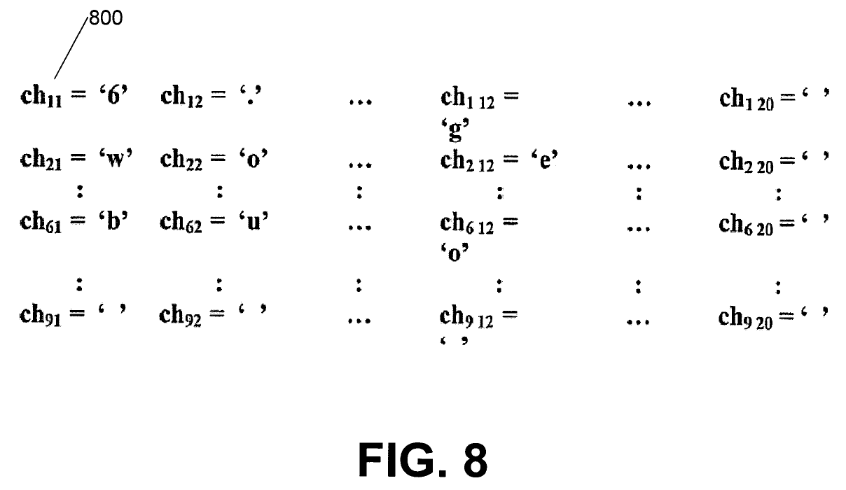

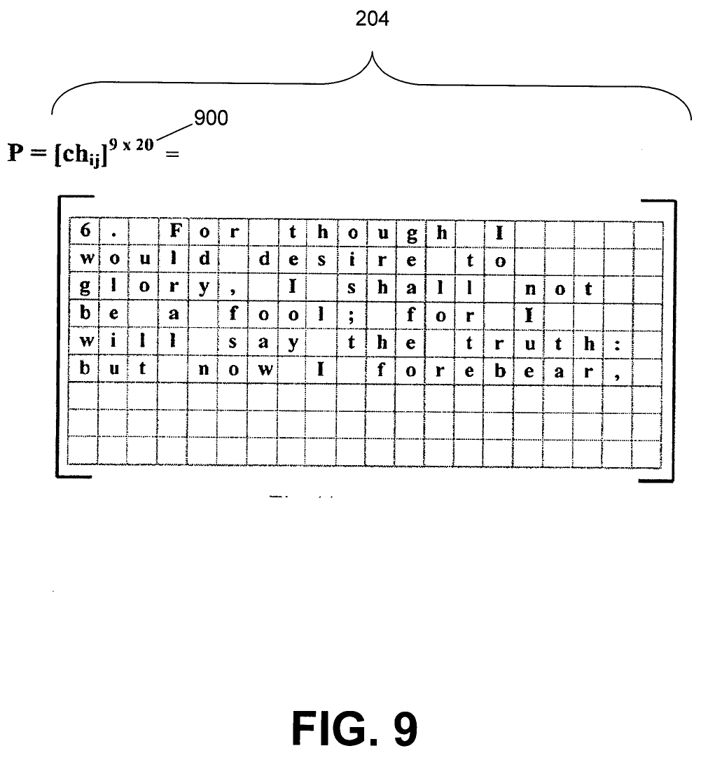

As an example, in FIG. 7 the screen 204 displays characters 700 according to the page (chᵢⱼ)^{r×s} of FIG. 6, where variables in the equation have been substituted with actual letters, but does not display the characters in a manner which is optimal for readability. In distinction, the readability-filtered array of 800 of FIG. 8 produces the display of FIG. 9, in which screen 204 shows an example of an already page-setup page P=[chᵢⱼ]^{9×20} (label 900) where variables in the equation have been substituted with actual letters.

Let us further define Pₖ as the k^{th} page-setup page within the chapter on which the characters are neatly arranged. From Equation 2, represent P by [chᵢⱼ]^{r×s}. Hence

Pₖ=[chᵢⱼ]^{r×s}ₖ (Equation 3)

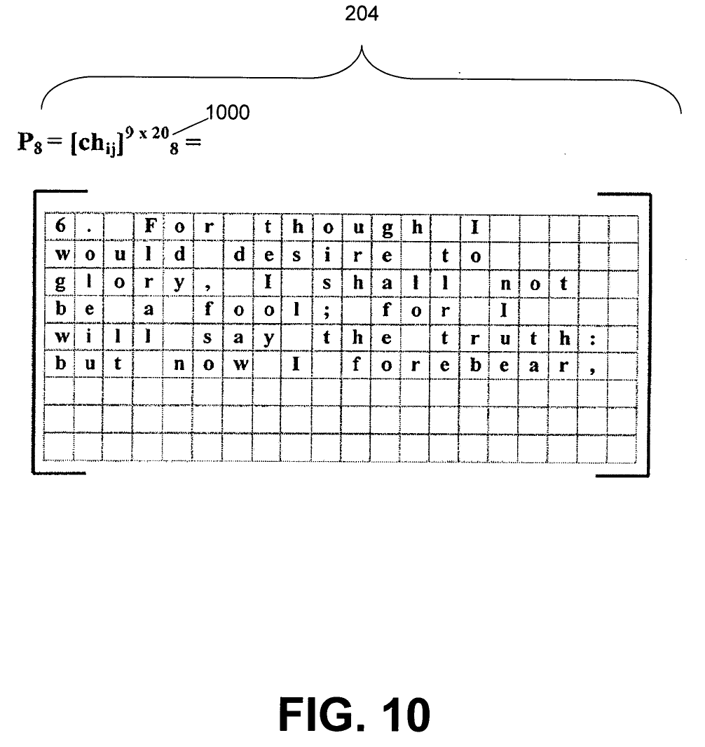

It represents the k^{th} page-setup page (r rows×s columns) within the chapter on which each character chᵢⱼ is neatly arranged in row i and column j. For example, referring to FIG. 10, the page shown in FIG. 3 and here on screen 204 can be represented by P₈=[chᵢⱼ]^{9×208}₈ (label 1000) as it comes from the page number 8.

### 4. Define ‘page-setup chapter’ as a Series of ‘page-setup pages’

Let us define Chapter^{ps} as the array of a series of all the page-setup pages within the Chapter. Chapter^{ps}=(P₁, P₂, . . . , Pₖ, . . . Pₙ) where n is the total number of pages within the chapter. For simplicity, use (Pₖ)ⁿ to represent the above one-dimensional array. Hence:

Chapter^{ps}=(P₁, P₂, . . . , Pₖ, . . . Pₙ)=(Pₖ)ⁿ=([chᵢⱼ]^{r×s}ₖ)ⁿ (Equation 4, derived from Equation 3).

Equation 4 represents a page-setup chapter of total n pages (r rows×s columns) while each character chᵢⱼ is neatly arranged in row i and column j on each page with

page number k. For example, starting with 32 page-setup pages (each of 9 rows×20 columns) in a chapter, the page-setup chapter can be represented by all the 32 pages on which all the characters are neatly arranged.

$$\begin{matrix}{Chapter}^{ps} = ( {P}_{1} , {P}_{2} , … , {P}_{k} , … {P}_{32} ) \\ = ( {[ {ch}_{ij} ]}_{1}^{9 \times 20} , {[ {ch}_{ij} ]}_{2}^{9 \times 20} , … , {[ {ch}_{ij} ]}_{k}^{9 \times 20} , {… [ {ch}_{ij} ]}_{32}^{9 \times 20} ) \\ = {( {[ {ch}_{ij} ]}_{k}^{9 \times 20} )}^{32}\end{matrix}$$

### 5. Define ‘time-stamped and page-setup chapter’ as a Series of ‘time-stamped and page-setup pages’.

This step entails defining the already time-stamped and page-setup chapters in order to produce synchronized and page-setup text for the ReadandHear format.
a. Representation of a time-stamped and page-setup chapter When the k^{th} page is time-stamped at time tₖ, represent the time stamp and the corresponding time-stamped page-setup page by (tₖ, Pₖ). Let us define Chapter^{ps & ts} as a time-stamped Chapter^{ps}. It can be represented by an array of n time-stamped page-setup pages with each page has its corresponding time-stamp. Hence

$$\begin{matrix}{Chapter}^{ps \& ts} = ( ( {t}_{1} , {P}_{1} ) , ( {t}_{2} , {P}_{2} ) , … ( {t}_{k} , {P}_{k} ) , … ( {t}_{n} , {P}_{n} ) ) \\ = {( ( {t}_{k} , {P}_{k} ) )}_{n} \\ = {( ( {t}_{k} , {[ {ch}_{ij} ]}_{k}^{r \times s} ) )}^{n}\end{matrix}$$

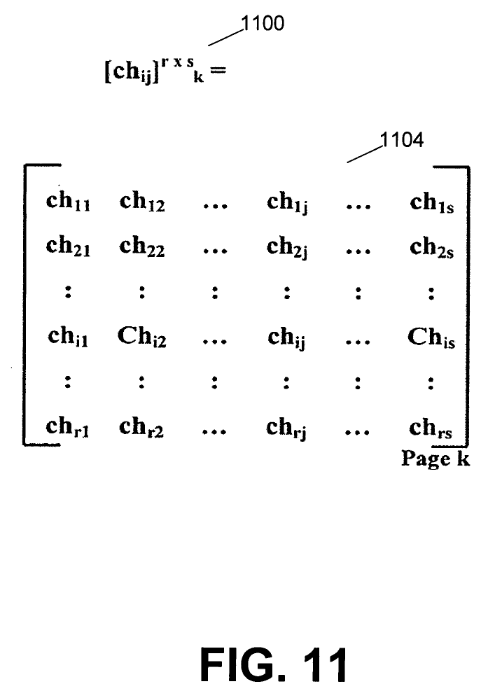

(from Equation 4), where [chᵢⱼ]^{r×s}ₖ(label 1100) is shown in FIG. 11 as an array 1104, and not as an on-screen display. Chapter^{ps & ts} represents the time-stamped and page-setup chapter of characters that comprises all the n time-stamped and already page-setup pages of size r rows×s columns.
b. An example of time-stamped and page-setup chapter

For example, a narration and text input of a chapter (2Cor. 12:) are as follows:
12: The Second Epistle of Paul the Apostle to the Corinthians Chapter Twelve
1. It is not expedient for me doubtless to glory. I will come to visions and revelations of the Lord.
2. I knew a man in Christ above fourteen years ago, [whether in the body, I cannot tell; or whether out of the body,
3. . . .
21. And lest, when I come again, my God will humble me among you, and that I shall bewail many which have sinned already, and have not repented of the uncleanness and fornication and lasciviousness which they have committed.

$$\begin{matrix}{Chapter}_{2 Cor . 12 \text{:}}^{ps \& ts} = {( ( {t}_{k} , {P}_{k} ) )}_{n} for n = 32 \\ = {( ( {t}_{k} , {[ {ch}_{ij} ]}_{k}^{r \times s} ) )}^{n} for n = 32 , r = 9 , s = 20 \\ = \text{(} ( [ 00 \text{:} 00.60 ] , {[ {ch}_{ij} ]}_{1}^{9 \times 20} ) , ( [ 00 \text{:} 02.32 ] {,}_{2}^{9 \times 20} ) , \\ ( [ 00 \text{:} 07.96 ] , {[ {ch}_{ij} ]}_{3}^{9 \times 20} ) , … , \text{(} [ 00 \text{:} 35.19 ] , \\ {[ {ch}_{ij} ]}_{8}^{9 \times 20} \text{)} , … , ( {t}_{k} , {[ {ch}_{ij} ]}_{k}^{9 \times 20} ) , … , [ 03 \text{:} 00.73 ] , \\ {[ {ch}_{ij} ]}_{32}^{9 \times 20} \text{))} .\end{matrix}$$

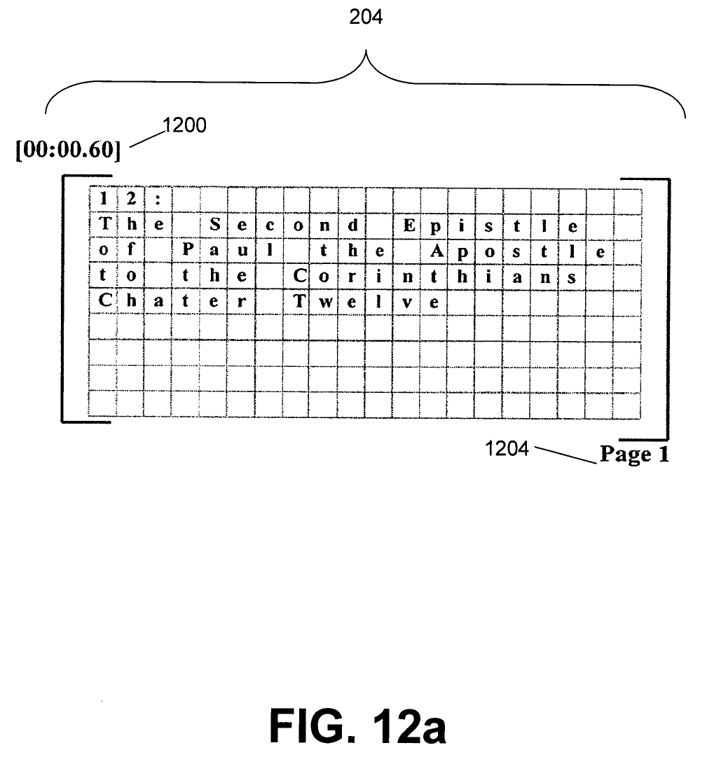

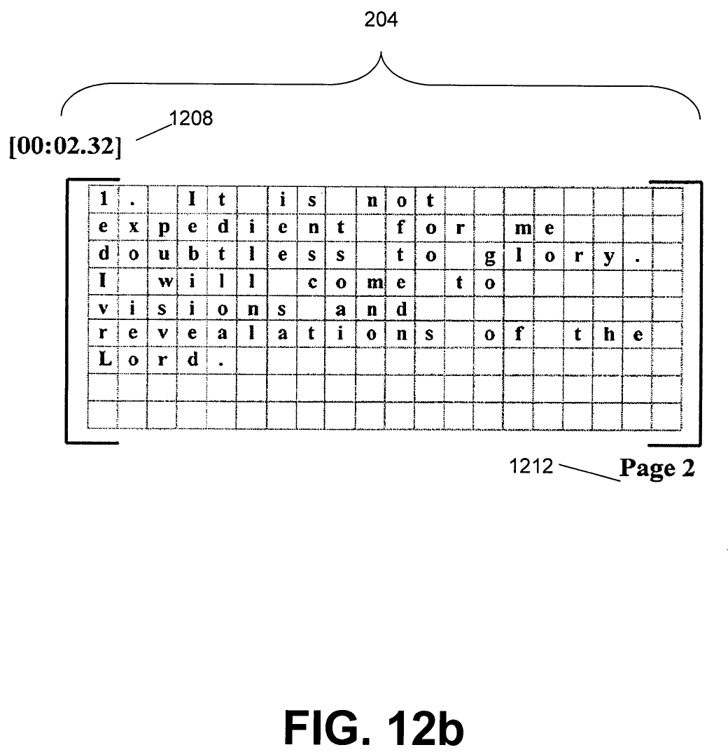

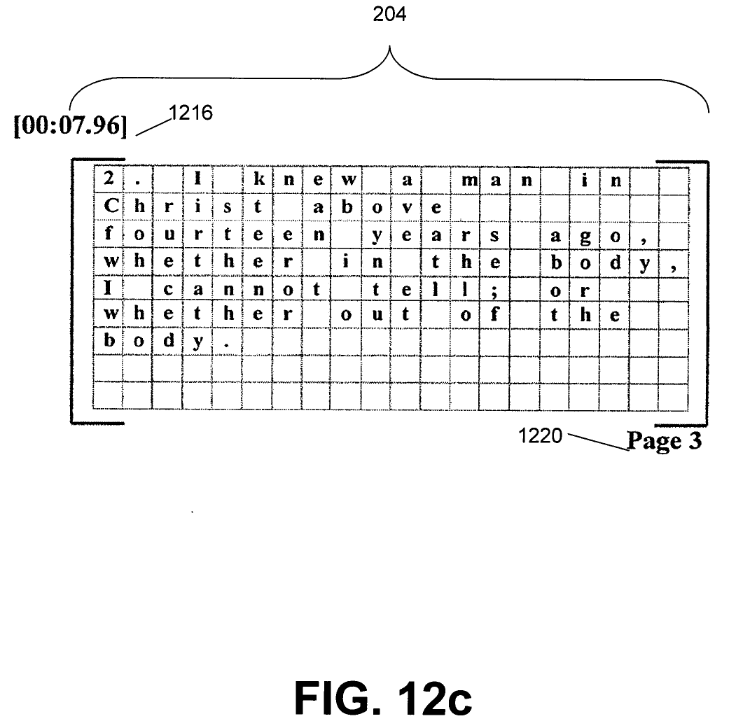

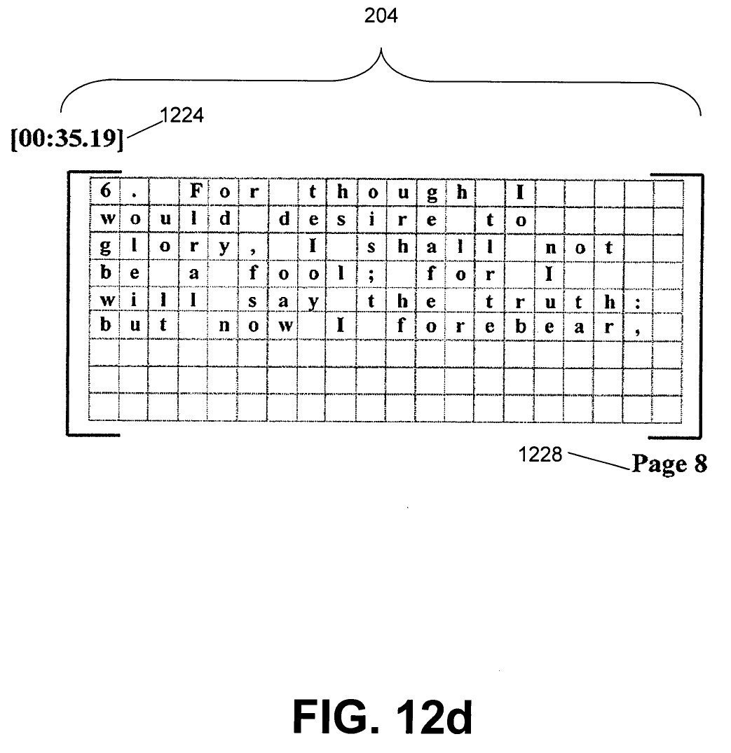

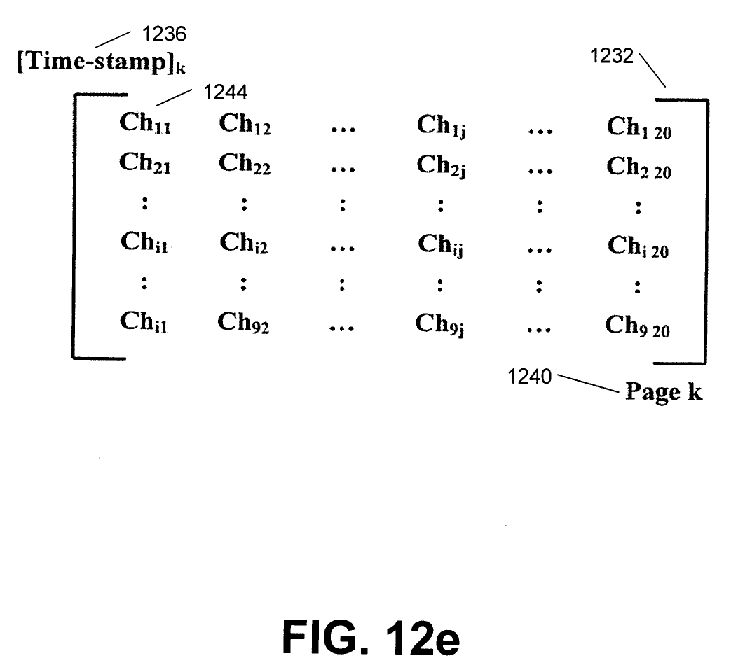

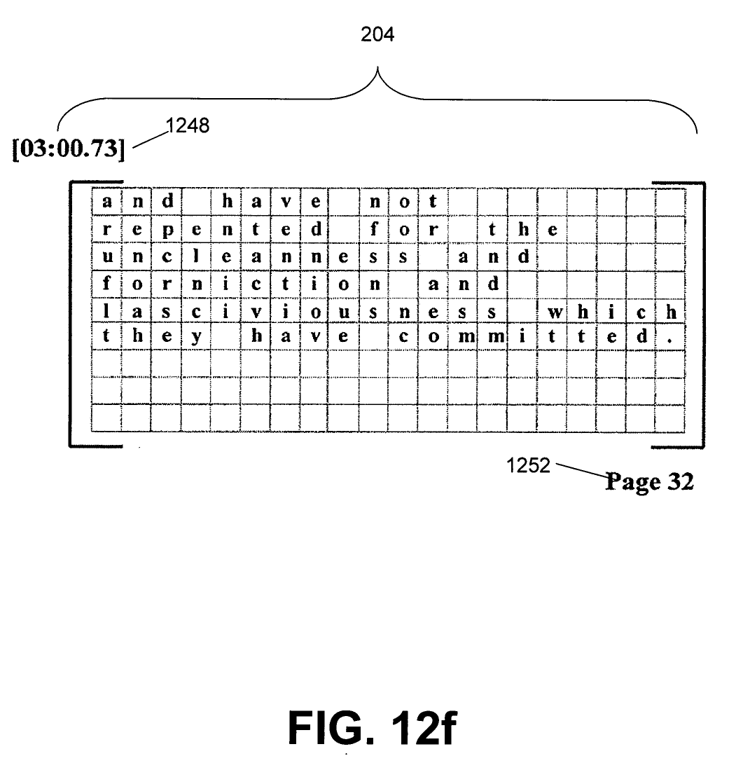

For better visualization and understanding, the above expression can be further presented as follows. Referring to FIGS. 12a-12f, an example of a complete text file in ReadandHear format is shown FIG. 12a shows the screen 204 showing the first page (label 1204) as it would appear at the first timestamp 1200. FIG. 12b shows the screen 204 showing the second page (label 1212) as it would appear at an immediately subsequent, second timestamp 1208. FIG. 12c shows the screen 204 showing the third page (label 1220) as it would appear at an immediately subsequent, third timestamp 1216. FIG. 12d shows the screen 204 showing the eighth page (label 1228) as it would appear at an later, eighth timestamp 1224. FIG. 12e shows the underlying matrix 1232 behind a given timestamp 1236 and page 1240, with each character's placement defined 1244. Finally, FIG. 12f shows the screen 204 showing page 32 (label 1252) as it would appear at the final timestamp 1248 of the chapter.

### 6. Add Audio Element to the ReadandHear File Format

Now having the text and the time-stamps, the audio data is needed in order to complete the construction of the new format. The ReadandHear file will comprise the audio file, the synchronized text and the already page-setup text information.

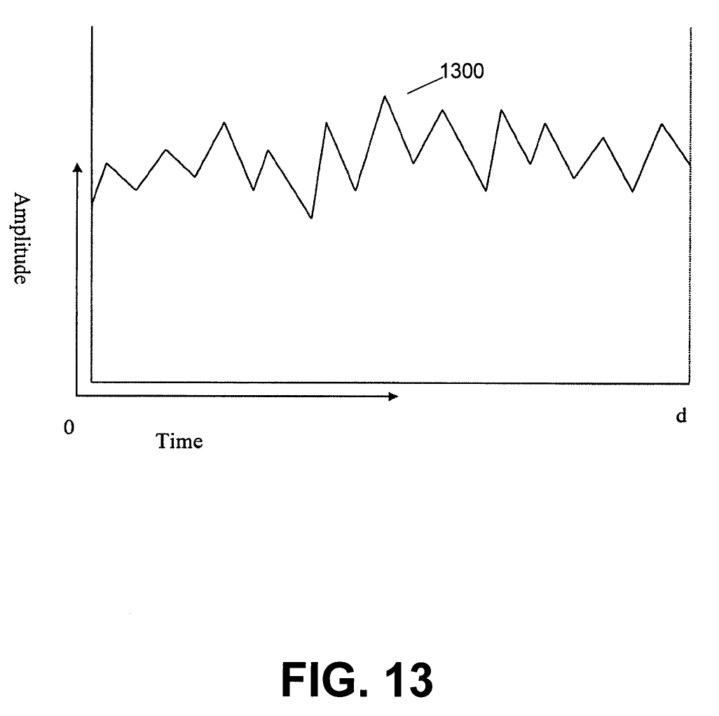

There are many types of audio formats available. In actual implementation, the audio wave can be a compressed file. It may be in mono, stereo, or have multi-channels. Although many audio files of various formats (such as MP3, WMA, OGG, MP3PRO, and AAC) can be encoded/decoded with standard software and other solutions available in the market, one useful and effective choice is to work with an Integrated Circuit manufacturer who is a licensee of MP3 technology to decode MP3. Although the term MP3 is used in the present presentation of ReadandHear files implementation, the application of this disclosure can be applied to various other kinds of audio formats. The ReadandHear apparatus, method, and file format, alone and together, combine the audio file with synchronized and page-setup text information. Since the audio part in the ReadandHear format is similar to that of the original input audio format, in order to describe the ReadandHear format, use the same general expression for digital audio wave. Referring to FIG. 13, a digital audio sound wave 1300 from time 0 to time d is represented by Audio-(0-d) as shown.

### 7. Define ReadandHear Format with Audio and Text

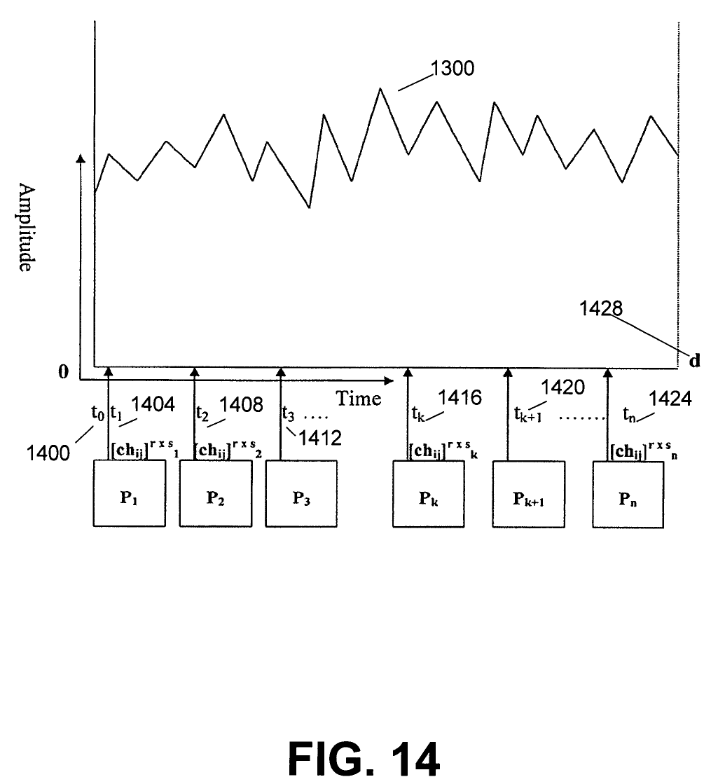

This step entails the definition of the ReadandHear format with audio and text in order to produce the final output. Suppose an input digital audio wave is represented by arbitrary Audio-wave(0-d) as shown in FIG. 13 where the initial time is set to ‘'0’ and ‘d’ is the duration of the voice file. The ReadandHear file would consist of:
Audio-wave(0-d) and ((tₖ, [chᵢⱼ]^{r×s})k)ⁿ
   plus some file overhead. Referring to FIG. 14, the diagram summarizes the structure of the ReadandHear format.
to (Label 1400)=time 0 at page-break point 0 when voice file (including background music) starts
t₁(Label 1404)=time-stamp at page-break point 1 when narration and text display start
t₂(Label 1408)=time-stamp at page-break point 2
t₃(Label 1412)=time-stamp at page-break point 3
tₖ(Label 1416)=time-stamp at page-break point k
tₖ₊₁(Label 1420) =time-stamp at page-break point k+1n=total number of pages
tₙ(Label 1424)=time-stamp at page-break point n when the last page starts
d(Label 1428)=duration of audio file

As shown here, the time stamps are embedded within the text, which is then combined with the audio file. However, this is only one example, and the reverse may be performed, where time or text markers are inserted into the audio file, and the audio file is then combined with the text.

Based on the disclosed apparatus, method, and file structure, and including the disclosed inventive synchronization and storage methods, users can construct a ReadandHear file which is suitable for audio and text in sync display on very small electronic devices. It can be further processed with compression, encryption or other processes.

### 8. Example Data Structure of the ReadandHear Format

The following data structure may be utilized in assembling a single file containing synchronized text and audio. This is merely one example, however, and others may be used according to the present disclosure.

At a data level, a complete compressed audio track may immediately followed by a complete copy of the text, with time stamps embedded in the text. In this way, the integrity and the continuity of the audio (like the audio of a chapter of a book) may be well preserved without breaking the audio into many portions. This may be contrasted with conventional methods of synchronization for multimedia presentation or interactive language learning, where a text file may be followed by an associated audio file. A single. file may used for a whole chapter, in the example of storage of the Bible, as opposed to individual filed for the verses as verse1_text_file, verse1_audio_file, verse2_text_file, verse2_audio_file, verse3_text_file, verse3_audio_file, etc.

The textual portion of the file may include verbose timestamps surrounded by brackets like [01:29.15], and may be placed in front of corresponding text to which audio should be synchronized in the corresponding time frame. If stored in this verbose format, whether in a working file or in the ultimate text file, the player may be configured to interpret a bracketed string as a time stamp only if the format within the brackets exactly corresponds to the form of [mm:ss.uu]; accordingly, text within brackets would not produce an error by being read as a timestamp. Should timestamps over an hour be needed, the format may easily be extended to the form of [h:mm:ss:uu]. However, the textual portion of the file may also be compressed to save space, and the time stamps may be further reduced or encrypted, so that the resulting text file may contain time stamps which are cannot be converted into time frames by visual inspection, but may still be read by the player when synchronizing the audio and text.

The textual portion of the file may be in any number of character sets, including (as non-limiting examples) 8-bit ASCII code, 16-bit Unicode 16-bit GB Code (Simplified Chinese), 16-bit Big 5 Code (Traditional Chinese) or any other Unicode standard. Through the use of Unicode, the text portion of the file may be stored in all languages supported by Unicode. As a non-limiting example, the present methods may be applied to Chinese text stored in an appropriate Unicode set, implemented with graphical characters synchronized with the text.

The audio portion of the data may be encoded and compressed in MP3 format, although other formats may be used.

Together, the file may, as a non-limiting example, consist of, in this order:

Audio-wave(0-d) and ((tk,[chᵢⱼ]^{r×s})k)ⁿ

One advantages of this format is that it preserves the simplicity of the audio wave and it does not require interleaving within the audio data, which may lead to bad sound quality or device errors, and which may require a larger device cache memory. Instead of breaking the audio-wave into many portions and interleaving with the text pages, the audio-wave is still presented as a continuous wave Audio-wave(0-d). When the file is played, the synchronization of the audio and the text is implemented through time stamps instead of interleaving.

Once the continuous audio-wave and the time-stamped page-setup information are combined into a single file, the file data can be further compressed and encrypted for better storage and data protection. But the compression and encryption is not a necessary requirement of the format.

### V. Generating an Output in ReadandHear Format

Once the ReadandHear file format has been defined, three processes are needed to produce an output in ReadandHear format.
1. Page-breaks generation
2. Audio and text synchronization
3. Information integration.

### A. Page-Breaks Generation Process for ReadandHear File Format

### 1. Define the Raw Data of Input Text

Described above are an input audio file, an input text file, and a set of page-setup criteria for the display page size. Usually, there is one text file and one audio file for a single chapter. There are many ways to define a Chapter in terms of characters. One of them is by paragraphs (or verses for scriptures).

Consider the following:
i—The character number in the paragraph
j—The paragraph number in the input file
Lj—The length of the j^{th} paragraph
m—The total number of paragraphs.

### Since ‘Chapter’ can be represented as the total number of paragraphs (m), hence,

Chapter=(Parⱼ)^{m}=((chᵢ)^{Lj}ⱼ)^{m}

where Parⱼ is the j^{th} paragraph with length Lj containing character chᵢ as an element. Let us use the following verse from the Bible as an example. (2Cor. 12:6)
“6. For though I would desire to glory, I shall not be a fool; for I will say the truth: but now I forbear, lest any man should think of me above that which he seeth me to be, or that he heareth of me.”
   Below illustrates how the raw input text data is defined:
a. The 4^{th} character ch₄ can used to describe the first letter of the verse which is the letter ‘F’.
b. Since the title of the Chapter is considered the first paragraph, the 7th paragraph Par₇ can be used to describe Verse 6.
c. Including space, there are 200 characters in Verse 6, hence the length of the paragraph L₇ is equal to 200.
d. Since the title of the Chapter is considered the first paragraph, and there are 21 verses in the chapter, the total number of paragraphs (m) is equal to 22.

### Therefore,

Chapter=(Parᵢ)²²

As discussed before, since the input text file has not been page-setup according to the display page size and the page-setup criteria, this format is not yet ideal for proper page display on the device. Moreover, the length of each paragraph (Lj) varies. Some paragraphs may be too long to display all on one screen. For example, the above verse has 200 characters, making it too long to fit on the 9×20 screen. At this point, one needs to identify where to break for a new page. During the page-breaks generation process, a software utility will rearrange every character according to its input coordinates and the page-break criteria.

### 2. Page-Break Criteria

To determine page-break points, the software program will try to arrange the words properly on a working page based on predefined criteria. The size of the working page is the same as the actual display page on the screen of a portable device such as a device about the size of a cellular phone.

Criteria for a neatly displayed page can be defined by the book publishers. In general, the software will fit as many words as possible in a page without violating the predefined criteria.

Software criteria for determining page-break points include all or some of the following:
a. A word cannot be broken and be displayed on 2 lines.
b. A short hyphenated word cannot be broken into two lines.
c. For a long hyphenated word, it can only be split at the hyphen.
d. A sentence ended with punctuation such as “.” or “,” cannot be broken up for display on 2 pages. In other words, page-breaks can only occur after punctuation.
e. For Bible, poetry, or other verse-based reading, a page-break occurs after the end of each verse.
f. If there are page-breaks within a paragraph or a verse, check the last page to see if there are too few words to display for the entire screen of the last page. If so, then take the previous sentence that ends with punctuation from the preceding page, and place it on the last page as well.

The above criteria are non-limiting examples, and other criteria may be used.

### 3. Apply Page-Break Criteria

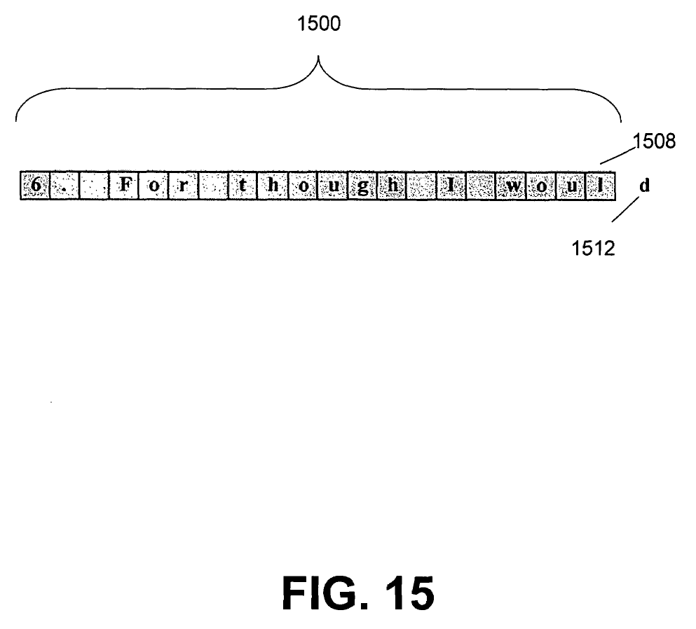

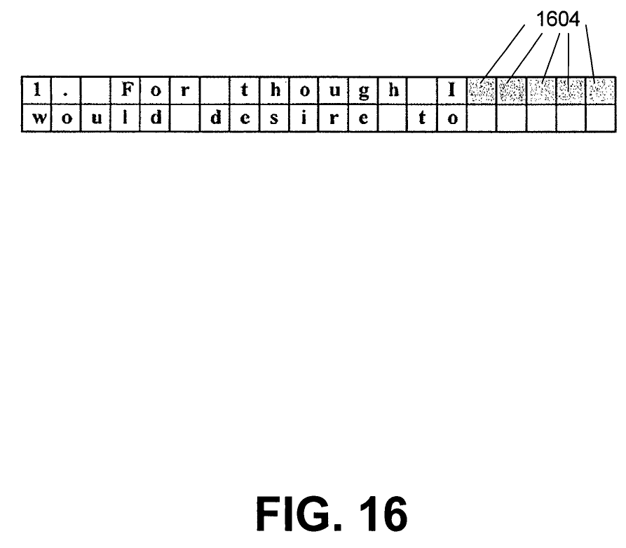

For example, take the following verse:
“6. For though I would desire to glory, I shall not be a fool; for I will say the truth: but now I forbear, lest any man should think of me above that which he seeth me to be, or that he heareth of me.”
   Referring to FIG. 15, the software will try to place the first sentence of the verse on the working page 1500. If it puts “woul” 1508 in the first line and “d” 1512 in the second line, the word “would” will be ‘broken’ and displayed on two lines. In this case, the software will start over after the preceding word which is ‘I’. It then fills the spaces to the end of the line of the working page with a “null” character. The “null” character takes one character space but displays nothing. The software then places the word “would” in the second line. Referring to FIG. 16, the outcome will appear as shown, where the word “would” 1600 now appears on the second line, and “null” characters 1604 fill the remainder of the first line. The software will then continue to process subsequent lines using the same algorithm.

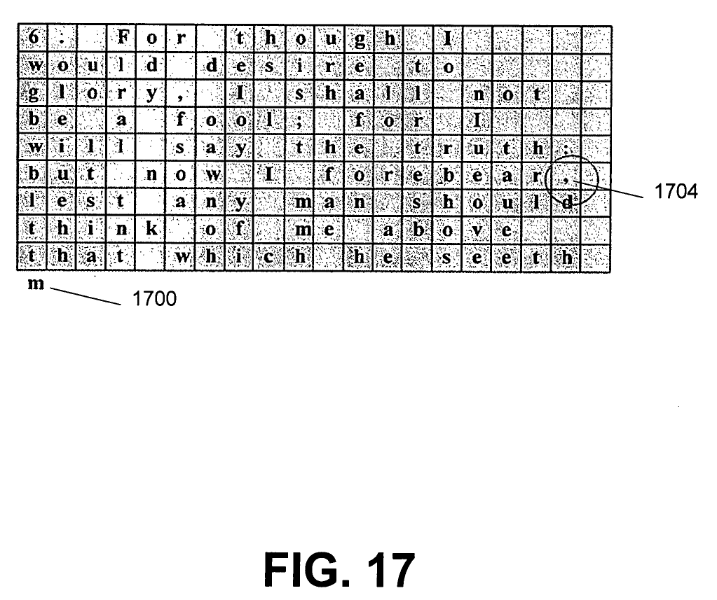

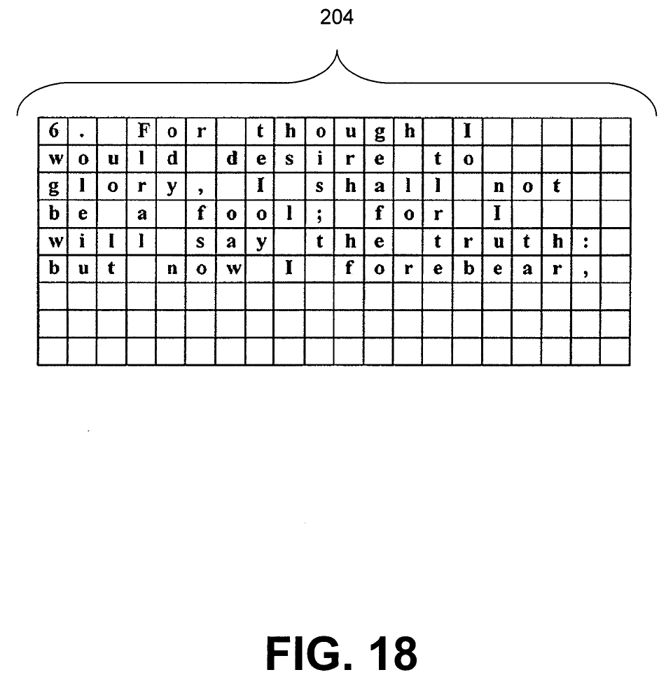

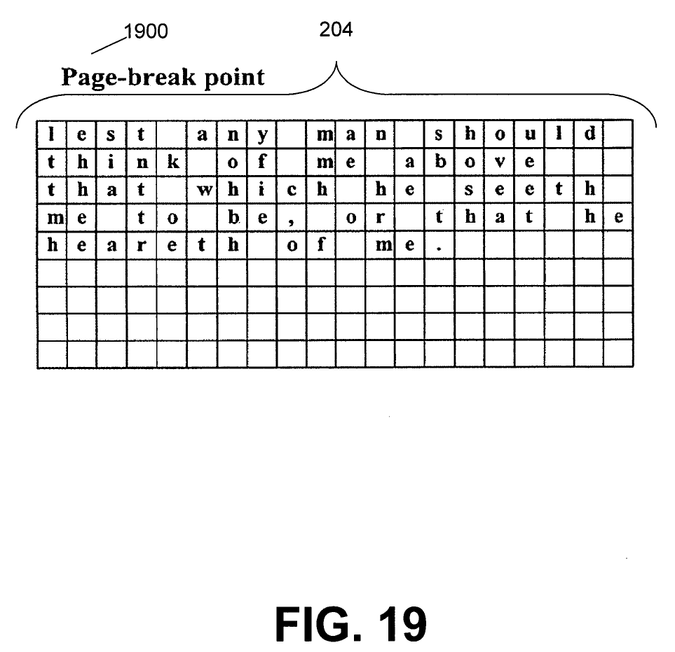

To build a page, the software will try to arrange characters on the working page by following some of the predefined criteria. Referring to FIG. 17, for example, there is not enough room on the working page to fit the entire sentence “lest any man should think of me above that which he seeth me to be,”, as evidenced by the improper placement of the character m 1700. Based on one of the predefined criteria, which is, page-breaks can only occur after punctuation, the software will search backward for punctuation in order to prevent a phrase from being broken into two and getting displayed on two separate pages. As a result, this working page will end with “forebear,”, where a comma 1704 is identified, and the resulting pair of formatted pages will be shown on screen 204 as shown in FIGS. 18 and 19, separated by a page break point (label 1900).

It should be noted that the above disclosure assumes that the process of page formatting and preparation is performed when preparing the ReadandHear file or files for distribution, and not at the actual device where the synchronized text and audio will be viewed and heard. As such, the file is preconfigured for a screen of a given dimensions, and the above criteria are applied only once during preparation of each part of the ReadandHear file or files. Also, the formatting is performed at a machine with presumably greater processing power than the device where the file will eventually be deployed. However, in other examples, where processing demands are not so great, or where page size is not of fixed width, one or more of these criteria may be applied at the end device. In any case, the application of any number of these criteria to the file before its storage on the portable device allows for accurate synchronization with low processing demands.

### 4. The Output of Page-Breaks Generation

As the page-breaks generation process completes, each character will be assigned a new set of coordinates, (i, j). Each character will also get a new value for ‘k’ which indicates which page (k) it is in. These are the same as those defined in Equation 4. In other words, the output is the input of Equation 4. A page-setup page is defined from the page-setup characters. These characters have already been page-setup. Based on Equation 4, the page setup chapter can be defined in this way. A chapter with page-setup information comprises all the n page-setup pages (r rows×s columns) can be defined by using the same equation:

Chapter^{ps}=([chᵢⱼ]^{r×s}ₖ)ⁿ.

### Using the page-setup information, and the identified page-break points, the audio and the text for a page can be synchronized.

### B. Synchronization Process for ReadandHear File Format

The entire synchronization process can be executed automatically by the computer first. Quality assurance and error corrections can then be performed manually on the computer by an operator. In this case, there is no need for the operator to time-stamp all the operating lines, he or she only needs to focus on the few that have synchronization problems. The operator can simply mark the operation lines that have unsatisfactory synchronization results, and correct them using the ‘click-on-the-page-break-point’ method.

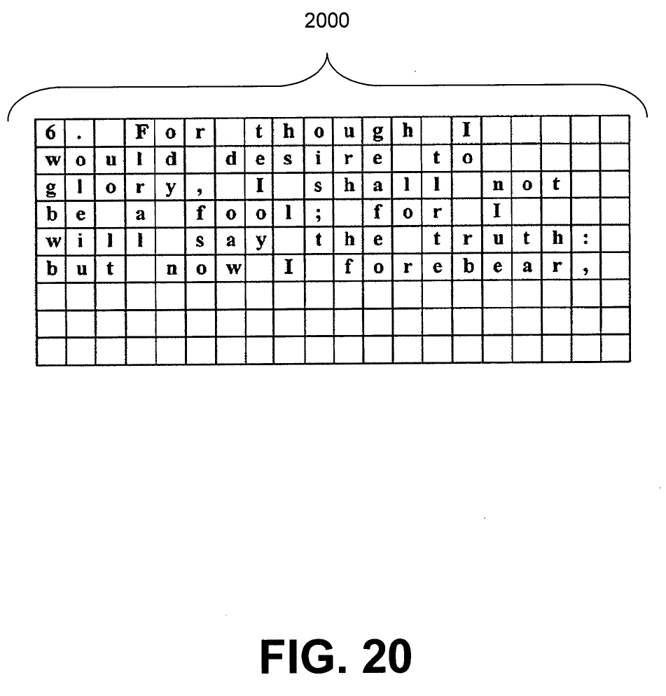

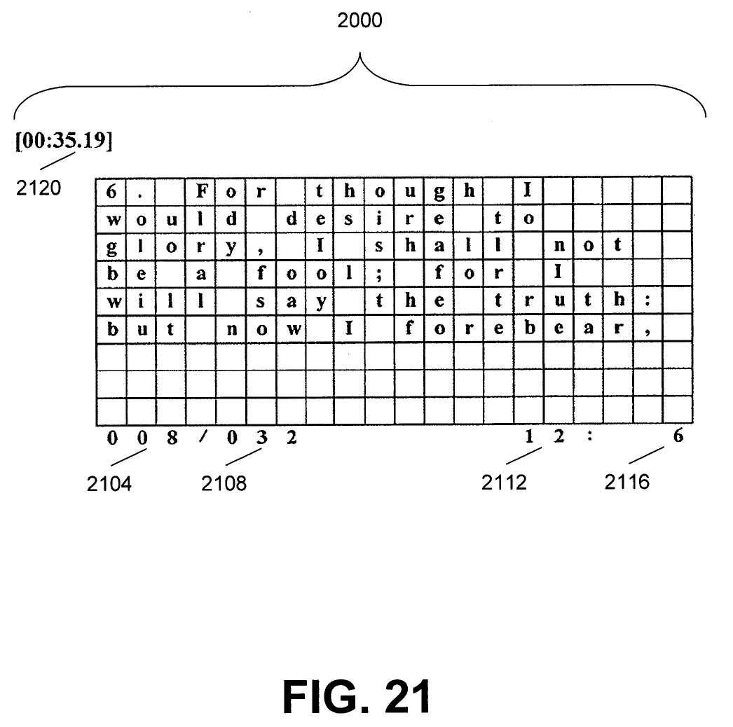

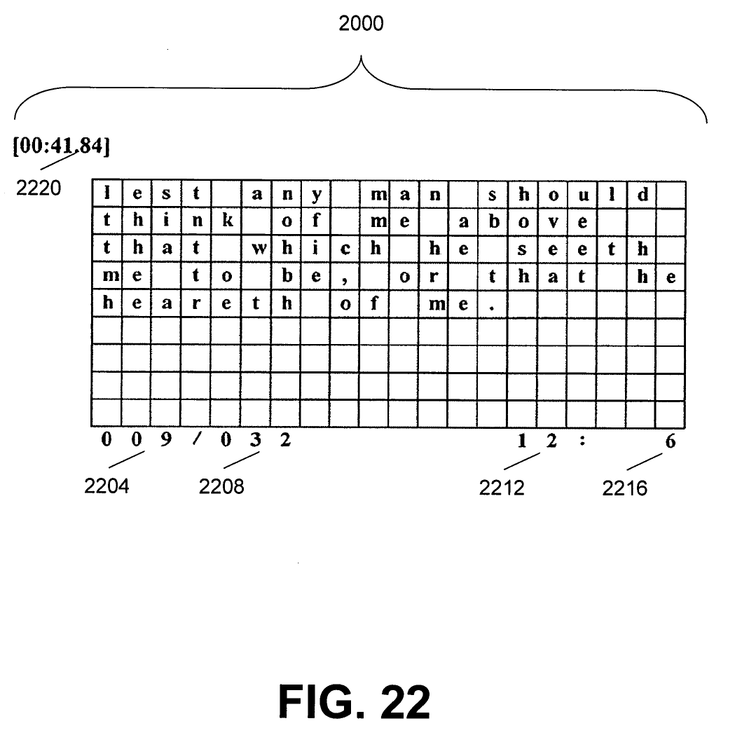

In order to provide synchronized audio and text for the ReadandHear apparatus, method, and file format, a software utility has been developed to help an operator time-stamp the page-break points. A non-limiting example of the synchronization process now follows.
a. When the operator starts to play the narration file, the utility sets the computer clock. The initial time is set to 00:00.00.
b. While listening to the narration through a headphone, the operator will also visually follow the corresponding text content in a specially designed sync-operating file.
c. In the sync-operating file, words are arranged in operating lines for easy reading. Each operating line in this file is equivalent to a working page in the page-breaks generation process. For example, an operating line in the synchronization process is:
   [time-stamp]6. For though I would desire to glory, I shall not be a fool; for I will say the truth: but now I forbear,
   [time-stamp]
      The operating line in the synchronization process is equivalent to a working page in the page-breaks generation process. Referring to FIG. 20, the working page is shown as it might appear on the synchronizer's screen 2000 before commencing the time stamp process.
d. Initially, the cursor stays at the beginning of the first operating line. The narration usually begins after some background music or silence. At the first mouse click by an operator, the software utility time-stamps the time lapsed ti with respect to the initial time which is set to 0. This is illustrated in FIG. 21, where synchronizer's screen 2000 optionally displays a page number 2104, total page number 2108, chapter number 2112, verse number 2116, and beginning timestamp 2020. Then the cursor automatically jumps to the start of the second line.
e. When the narration comes to the start of the second operating line, as illustrated in FIG. 22, the line is already being displayed on the screen 2000, along with a new page number 2204, and the total page number 2208, along with chapter number 2212 and verse number 2216. The operator simply clicks the mouse to time-stamp the time lapsed t₂ with respect to the initial time 0 for the second operating line (timestamp 2220).
f. When the narration comes to the start of the k^{th} operating line, the operator clicks the mouse to time-stamp the time lapsed tₖ with respect to the initial time. In this way, all the working page-break points can be time-stamped.

Example of a Time-Stamped Text File

The following shows the time stamps of the page-break points. The page-break points are at the beginning of each operating line, marked by β here in this document only for better readability and understanding.
[00:00.54]β1 11: The 2nd Book of Moses called Exodus Chapter Eleven
[00:01.69]β2 1. And the LORD said unto Moses, Yet will I bring one plague more upon Pharaoh, and upon Egypt;
[00:08.03]β3β afterwards he will let you go hence: when he shall let you go, he shall surely thrust you out hence altogether.
[00:14.78]β4 2. Speak now in the ears of the people, and let every man borrow of his neighbour,
[00:19.23]β5 and every woman of her neighbour, jewels of silver and jewels of gold.
[00:23.97]β6 3. And the LORD gave the people favour in the sight of the Egyptians. Moreover the man Moses was very great in the land of Egypt,
[00:30.61]β7 In the sight of Pharaoh's servants, and in the sight of the people.
[00:34.03]β8 4. And Moses said, Thus saith the LORD, About midnight will I go out into the midst of Egypt:
[00:40.02][β9 5. And all the firstborn in the land of Egypt shall die, from the first born of Pharaoh that sitteth upon his throne,
[00:46.77]β 10 even unto the firstborn of the maidservant that is behind the mill; and all the firstborn of beasts.
[00:52.42]β 11 6. And there shall be a great cry throughout all the land of Egypt, such as t here was none like it, nor shall be like it any more.
[00:59.71]β12 7. But against any of the children of Israel shall not a dog move his tongue,
[01:03.91]β13 against man or beast: that ye may know how that the LORD doth put a difference between the Egyptians and Israel.
[01:11.12]β14 8. And all these thy servants shall come down unto me, and bow down themselves unto me, saying, Get thee out,
[01:18.14]β15 and all the people that follow thee: and after that I will go out. And he went out from Pharaoh in a great anger.
[01:25.07]β 16 9. And the LORD said unto Moses, Pharaoh shall not hearken unto you; that my wonders may be multiplied in the land of Egypt.
[01:32.85]β17 10. And Moses and Aaron did all these wonders before Pharaoh: and the LORD hardened
   Pharaoh's heart,
[01:37.85]β18 so that he would not let the children of Israel go out of his land.

In this example, the chapter number ‘11:’ and the verse numbers such as ‘1.’, and ‘2.’, etc., are for display only. These need not narrated or included in the audio files. The narration does include the title of the chapter. All text may be time-stamped and displayed on the screen starting with the title of the chapter in page one.

### C. Information Integration Process for ReadandHear File Format

1. The process of integrating various types of information for the ReadandHear file format is rather simple. Text, audio, page-setup, and synchronization information are integrated to produce a single output file.
2. During the information integration process, it is important to utilize as little memory as possible to improve processing efficiency. Therefore, in actual programming, one may not need to store a two-dimensional array for the page setup information for each page. In fact, one can add “null” characters to the lines of text so that when it is displayed, the text can be aligned in a neat and tidy way as a page on the screen. A null character takes a character space but will not be displayed. For example after adding some “null” characters to appropriate spaces, the following text:
   [00:35.19]6. For though I would desire to glory, I shall not be a fool; for I will say the truth: but now I forbear,
   [00:41.84] lest any man should think of me above that which he seeth me to be, or that he heareth of me.
   [00:47.78]7. . . .

will become
[00:35.19]6. For though I would desire to glory, I shall not be a fool; for I will say the truth: but now I forbear,
[00:41.84] lest any man should think of me above that which he seeth me to be, or that heheareth of me.
[00:47.78]7. . . .
   When the electronic device interprets the line of characters with length r times s, it can easily transform them to be a page of r row and s columns. In this way, a device can display a neat and tidy text page and deliver narration in sync with the text, and in real-time. For devices with more processing capabilities, the processor can be free to do other tasks instead of concentrating on the page-setup tasks.

### VI. Download Output ReadandHear Files from Development Platform to Production Environment

When the development of ReadandHear output file is completed, they need to be downloaded from the PC development platform to small devices about the size of a cellular telephone for presentation to end-users. Using this small device, a person can now read published content and listen to the narration at the same time. The ReadandHear files that contain all of the text content of the publication, its narration audio, page-setup and audio-text synchronization are now physically stored on the small device about the size of a cellular telephone.

### A. Example of Download Files

Using the Bible as an example, there are altogether 1,189 ReadandHear files for the whole Bible with one file per chapter. These files are organized by the Book they belong to in the Bible. Below are sample file names in the downloading process.

```
Directory Files
(Book) (Chapters)
Genesis-------- Genesis_Chapter1.ats
          Genesis_Chapter2.ats
          Genesis_Chapter3.ats
          .
          .
          .
    Matthew--------Matthew_Chapter1.ats
            Matthew_Chapter2.ats
          Matthew_Chapter3.ats
          .
          .
          .
    Mark------------Mark_Chapter1.ats
                  Mark_Chapter2.ats
                  Mark_Chapter3.ats
                .
                .
                .
        Revelation-- --Revealation_Chapter1.ats
                      Revelation_Chapter2.ats
                      Revelation_Chapter3.ats
```

### B. Inconsistency in Operating System Download

As noted above, during download, an operating system may at times send the files to a portable device not in the same order as they are sorted on the PC. In addition, the file order may be inconsistent every time that the operating system downloads the same set of files to different devices. This can cause books, chapters, or other text units to be out of sequence in indexing on the portable device. Further, once on the portable device, users themselves may not be able to easily rearrange the files. Mass production may involve downloading over one thousand files to potentially millions of portable devices. The inconsistency in downloading presents a major problem for distribution when the files downloaded are not in the same logical order as the content of publication. Accordingly, novel download methods will now be disclosed.

### C. Enhanced Download Methods

A software utility is developed to run on the portable device to ensure that the book directory and chapter files downloaded are always in the same logical sequence as the content of book.

When the chapter files are sent to the portable device, the custom software on the portable device will check the name of the file against the names on an existing list. If the file belongs to a certain book directory, as indicated by a similarity of marker in the file name, then the file will be placed into a memory buffer of that directory. The files of that directory will then be arranged in the proper order before they are placed in a specified memory location that is reserved for that book directory for a specified indexing sequence. The same method is applied for the chapter files. This method applies not only to the Books and Chapters of the Bible for example, but the books and chapters of other publications, such as (as a non-limiting example) the encyclopedia.

### VII. Presentation of Output in ReadandHear Format on Device

When a ReadandHear application is created, all information may be stored in the newly designed ReadandHear file format. The ReadandHear format with extension .ats may be used for the output file for presentation. Compression and/or encryption can be added in the final file output, or at any interim stage. The presentation process starts when an end-user selects certain text to be read. The device then plays the audio and displays the text according to the ReadandHear Format. The following shows how the device outputs the audio and text in the presentation process.

### A. Ways in which the Device Presents Audio and Text Output

1. The time is set to be 0 as when the voice file starts.
2. While playing the voice file, the device also performs another task. It checks the elapsed time and when it reaches time-stamp t₁ of the first page-break point, the device outputs the page-setup text [chᵢᵢ]^{r×s}₁ for page 1
3. The text stays on the screen from t₁ to t₂ until it reaches time-stamp t₂ of the 2^{nd} page-break point. Then the device outputs the page-setup text [chᵢᵢ]^{r×s}₂ for page 2.
4. The text stays on the screen from t₂ to t₃ until it reaches time-stamp t₃ of the 3^{rd} page-break point.
5. Similarly, when it reaches time-stamp tₖ of the k^{th} page-break point, the device outputs the page-setup text [ch_{ii]}^{r×s}ₖ for page k, the text stays on the screen from tₖ to tₖ₊₁ until it reaches time-stamp tₖ of the k^{th} page-break point.
6. When it reaches time-stamp tₙ of the n^{th} page-break point for the last page, the device outputs the page-setup text [chᵢᵢ]^{r×s}ₙ for the last page n. The text stays on the screen from tₙ to d until the voice file ends.

### B. Presentation of Output

When the electronic device interprets the files in ReadandHear format, it can easily play the narration and output the already page-setup text according to the time-stamp at the beginning of each page. Besides page-setup text, the device can also display the page number, total number of pages, chapter number, verse number, etc. The following part of the data helps illustrate the presentation process.

| | |
|---|---|
| P1. | [ ] 12:................ |
| | . |
| | . |
| | . |
| P8. | [00:35.19] 6. For though I would desire to glory, I shall not be |
| | a fool; for I will say the truth: but now I forbear, |
| P9. | [00:41.84] lest any man should think of me above that which he |
| | seeth me to be, or that he hearth of me. |
| P10. | [00:47.78]7. ............................... |
| . | |
| . | |
| . | |

P32 [ ].................................

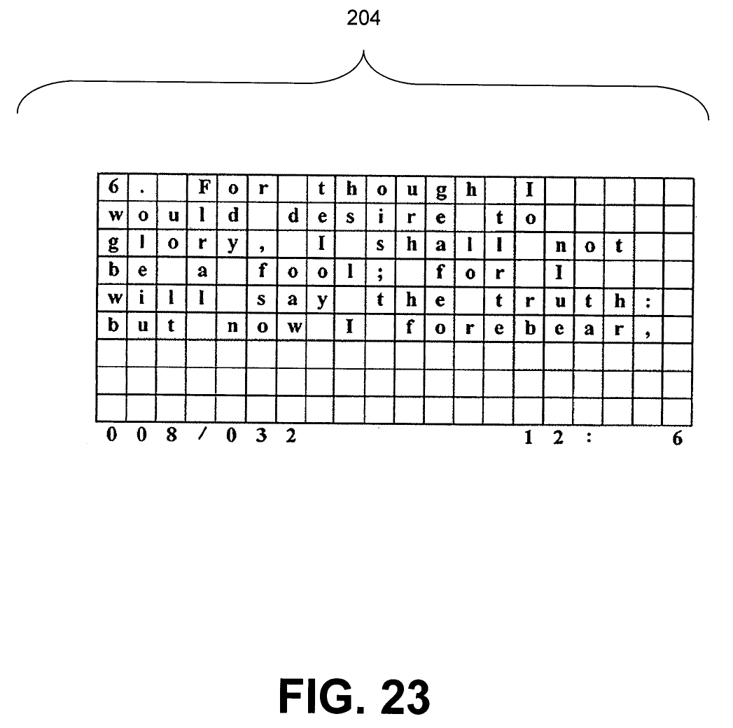

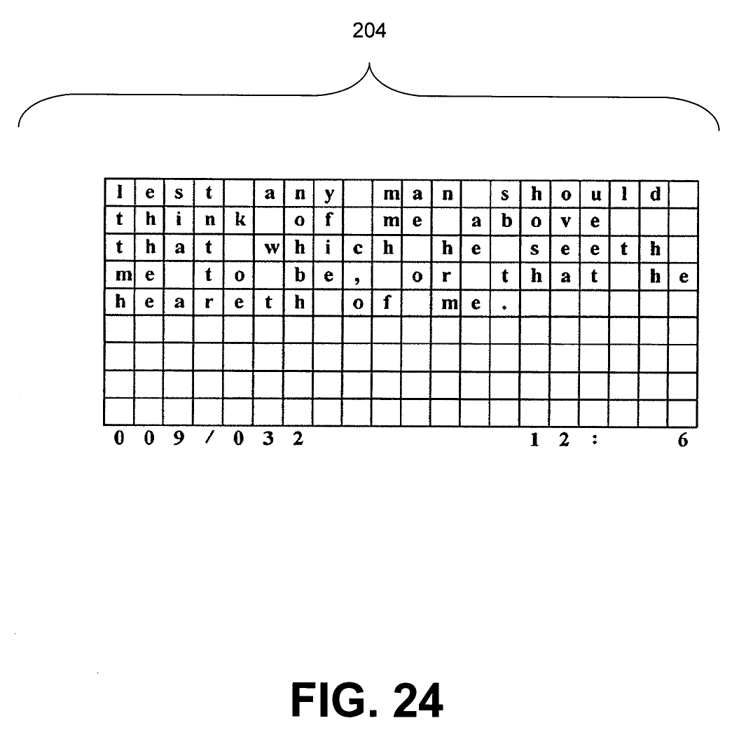

During the presentation of a chapter, the time is set to 0 when the voice file of the chapter starts. Referring to FIG. 23, the illustrated text, page number, total page number, chapter number, and verse number will be displayed on the screen 204 from [00:35.19] to [00:41.84]. Referring to FIG. 24, the illustrated text and numbers will be displayed on the screen 204 from [00:41.84] to [00:47.78].

### VIII. Implementation of ReadandHear File Format for ReadandHear Applications

### A. A New Standard Format for a New Way to Read

In the future, most books may be read and heard. The presently disclosed file format improves on any existing formats for developing synchronized applications. With the new format, book publishers can easily page-setup and present their published information on handy portable devices. This offers people a new way to enjoy published material by reading text and listening to synchronized narration on portable devices.

### B. Advantages of ReadandHear Applications Over Text-Reading Only or Audio-Listening Only

Although there are advantages to text-reading in paperback books, eBooks, and PDAs, etc., and there are benefits to audio-listening as found in specialized devices such as MP3 players. ReadandHear applications provide the best of both worlds. They offer all the advantages of “text reading” and “audio listening” as listed below:

### 1. Advantages of Text-Reading in the ReadandHear Method:

a. Text reading is a non-uniform pace experience that you can control. You can easily vary the speed of your reading.
b. One can pause at anytime to study any parts of the content in depth or share content with others for discussions.
c. It allows free navigation through different parts of the content.
d. Text reading lets readers learn the exact spelling of the words.

### 2. Advantages of Audio-Listening in the ReadandHear Method:

a. Human narration enhances feelings and memories of the content.
b. It lets the user feel the emotions such as joy or sorrow from the words of the content.
c. Listening is relatively easy and comfortable.
d. Listening lets readers know the precise pronunciation of the words.

Essentially, ReadandHear applications let you enjoy text-reading and audio-listening, alone and in synchronized format, all from a portable device such as a device about the size of a cellular phone. In addition, with ReadandHear applications, even if you vary the speed of narration, synchronization between audio and text remains whether you slow down or speed up the pace of the narration.

### C. The First Practical ReadandHear Application—the Holy Bible

The presently disclosed method may be embodied in the placement of the entire Holy Bible on a cellular-phone-size ReadandHear player, which may be referred to as the “ReadandHear Bible.” The ReadandHear Bible lets people read and hear the Bible anywhere. The choice of the Bible as the first practical application of the disclosure was made because this new file format and the new device can help people read the Bible more often. For the first time, there is a new way to read the Bible.

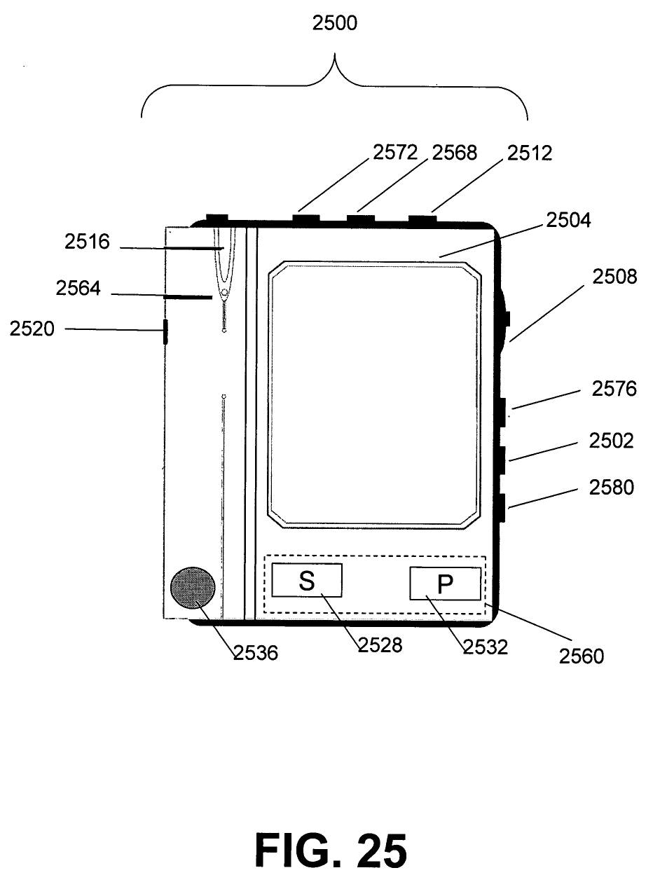

In FIG. 25, one embodiment of the ReadandHear apparatus 2500, as configured for the Bible, is illustrated. The apparatus 2500 includes a display 2504 for displaying the text and an audio output device for playing the audio narration (here, including a headphone jack 2520 along with any headphones or any audio processing circuitry or processors). As shown in cutaway 2560, storage device 2528 is configured to store data corresponding to the text and data corresponding to an audio narration of the text, which may be flash memory, a hard drive, or any other storage device. Also as shown in cutaway 2560, processor 2532 comprises the instructions needed for synchronizing the audio narration and the text based on synchronizing information embedded in the text data, the audio data, or both. The device may comprise a different audio output device, such as a speaker 2536, although the choice of audio output devices is not limited to those shown here. Additional optional elements include a scroll wheel 2508 which may be scrolled up or down to, as a nonlimiting example, modify the playback rate of the narration (and thus the synchronized display rate of the text), or which may be clicked inward for selections from a menu or from text on the screen, a power button 2512, an indicator light 2516 to indicate power or mode of operation, a microphone 2564 and/or audio line input 2568 for recording annotations, commentary, lectures, or information regarding the displayed text or other information, a data input port 2572 such as a USB port for uploading text and audio to the device for playback, control buttons such as (as non-limiting examples) escape key 2576, menu key 2502, and delete key 2580 for accessing and utilizing menus to set device features, or to jump the user to a different chapter or verse. The device may be powered by a battery (not shown). The device may include any number of other optional features, including a dictionary, an audio equalizer, speed control, music storage and playback, storage and playback of other files in formats such as TXT, HTML, DOC, HAT, MP3, and WMA, and control of font size and display features such as brightness.

ReadandHear Bible works excellently in demonstrating the present disclosure. This disclosure not only helps build the foundation for the 21st Century Bible, but also enables production of the first and only complete talking Bible. Benefits of the ReadandHear Bible include mobility, human voice, audio and text in sync, proper page-setup, fast indexing, free navigation, and adjustable audio speed while maintaining text synchronization.

Those of skill in the art will understand that information and signals may be represented using any of a variety of different technologies and techniques. For example, data, instructions, commands, information, signals, bits, symbols, and chips which may be referenced throughout the above description may be represented by voltages, currents, electromagnetic waves, magnetic fields or particles, optical fields or particles, or any combination thereof.

Those of skill will further appreciate which the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal. “Storage medium” may represent one or more machine readable mediums or devices for storing information. The term “machine readable medium” includes, but is not limited to, wireless channels and various other mediums capable of storing, containing, or carrying instructions and/or data.

The previous description of some aspects is provided to enable any person skilled in the art to make or use the present invention. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. Further, one or more of the aspects can be implemented by hardware, software, firmware, middleware, microcode, or any combination thereof. Thus, the present invention is not intended to be limited to the aspects shown herein but is to be accorded the widest scope consistent with the principles and novel features disclosed herein.

Having described the invention in detail and by reference to the aspects thereof, it will be apparent that modifications and variations are possible, including the addition of elements or the rearrangement or combination or one or more elements, without departing from the scope of the invention which is defined in the appended claims.

What is claimed is:

1. A method of synchronizing an audio narration of a text with a display of the text, the text and audio narration being encoded in a data file, and the method comprising the steps of:
performing a page setup operation for displaying the text in a predetermined sequence;
displaying the text in accordance with the page setup operation;
outputting the audio narration of the text; and
synchronizing the audio narration and the displayed text, wherein synchronizing information is embedded in a text portion of the data file.

2. The method of claim 1, wherein the synchronizing information comprises timestamps.

3. The method of claim 1, wherein the audio narration and text are encoded in the same data file.

4. The method of claim 1, wherein the page setup operation utilizes null characters embedded in the text based on an anticipated display screen size.

5. The method of claim 1, wherein the page setup operation utilizes paragraph marks embedded in the text based on an anticipated display screen size.

6. The method of claim 1, wherein said synchronizing step occurs as part of the page setup operation.

7. The method of claim 1, wherein said synchronizing step occurs as part of the displaying step.

8. The method of claim 1, wherein the method is implemented on a hand-holdable device having a display and an earphone jack.

9. The method of claim 1, wherein the method is implemented on a hand-holdable device having a display and a speaker.

10. The method of claim 1, wherein the page setup operation addresses at least one readability factor selected from the group consisting of: preventing a word from breaking across two lines; splitting a hyphenated word at the hyphen; placing a page-break only after punctuation; and combinations thereof.

11. The method of claim 1, wherein the text is stored in a first data file and the audio narration is stored in a second data file.

12. The method of claim 1, wherein the page setup operation is configured for use with a chapter-and-verse style document.

13. A method of synchronizing an audio narration of a text with a display of the text, the text and audio narration being encoded in a data file, and the method comprising the steps of:
performing a page setup operation for displaying the text in a predetermined sequence;
displaying the text in accordance with the page setup operation;
outputting the audio narration of the text; and
synchronizing the audio narration and the displayed text, wherein synchronizing information is embedded in an audio portion of the data file.

14. An apparatus for enabling a user to simultaneously read and hear a text, the apparatus comprising:
a storage device configured to store data corresponding to the text and data corresponding to an audio narration of the text;
a display for displaying the text;
an audio output device for playing the audio narration; and
a processor comprising instructions for synchronizing the audio narration and the text based on synchronizing information embedded in the text data, the audio data, or both.

15. The apparatus of claim 14, wherein the processor further comprises instructions for performing a page setup operation for displaying the text in a predetermined sequence, the page setup operation addressing at least one readability factor selected from the group consisting of: preventing a word from breaking across two lines; splitting a hyphenated word at the hyphen; and placing a page-break only after punctuation.

16. The apparatus of claim 14, wherein the apparatus is contained within a hand-holdable device.

17. The apparatus of claim 14, wherein the audio output device comprises a speaker.

18. The apparatus of claim 14, wherein the audio output device comprises an audio output jack configured for use with headphones.

19. A file formatted for enabling a display of text and a synchronized audible narration of the text, the file comprising:
textual data corresponding to the text; and
audio data corresponding to the audible narration of the text,
wherein the textual data comprises synchronization data embedded within the text.

20. The file format of claim 19, wherein the textual data further comprises page setup information sufficient for a processor to perform a page setup operation without the use of xml tags.

21. The file format of claim 19, wherein the textual data is preconfigured for a display of a specified size.
